(19) United States
(12) Patent Application Publication
(10) Pub. No.: US 2026/0367551 A1
(43) Pub. Date: Nov. 19, 2026

(54) IMAGE FORMING APPARATUS

(71) Applicant: CANON KABUSHIKI KAISHA, Tokyo (JP)

(72) Inventors: HIROTO ITO, Chiba (JP); KOICHI KAKUBARI, Chiba (JP); SHIGERU HIRANO, Tokyo (JP); MADOKA WATANABE, Chiba (JP); SHIGERU TANAKA, Tokyo (JP)

(21) Appl. No.: 19/637,289

(22) Filed: Apr. 2, 2026

(30) Foreign Application Priority Data
May 13, 2025 (JP) 2025-080594
Jun. 9, 2025 (JP) 2025-095683

(51) Int. Cl. G03G 15/20; G03G 15/08; G03G 21/20

(52) U.S. Cl. CPC G03G 15/2039; G03G 15/0863; G03G 15/0877; G03G 15/2064; G03G 21/206; G03G 2215/0697; G03G 2221/1645

(57) ABSTRACT

An image forming apparatus includes a fixing portion including a fixing rotating member, and a pressure rotating member that abuts on the fixing rotating member to form a nip portion, a fixing cooling portion that cools the fixing rotating member or the pressure rotating member, and a controller that performs a cooling operation using the fixing cooling portion, and a storage portion that stores characteristic information of a contained toner, in which, at the time of performing the cooling operation using the fixing cooling portion, a setting temperature is corrected based on the characteristic information of the toner stored in the storage portion, and the cooling operation using the fixing cooling portion is performed until a temperature of a region through which outside a second region in a first region of the nip portion reaches the corrected setting temperature.

### BACKGROUND

### Field of the Technology

The present disclosure relates to an image forming apparatus that forms an image on a recording material.

### Description of the Related Art

In a conventional image forming apparatus, when a job in which a small-sized recording material of which a size in a width direction orthogonal to a conveyance direction of the recording material passing through a nip portion of a fixing device is smaller than that of the nip portion is continuously executed, in the nip portion, a so-called non-passing portion temperature rise in which a temperature rise in a portion where the recording material does not pass is larger than that in a portion where the recording material passes occurs. Here, when a large-sized recording material passes immediately after the small-sized recording material passes, a non-passing portion of the small-sized recording material in the nip portion has a high temperature. Therefore, excessive melting of the toner occurs in the non-passing portion, and a phenomenon called hot offset occurs in which the overmelted toner remains on a surface of a fixing member.

In order to prevent this, Japanese Patent Application Laid-Open No. 6-348175 proposes a cooling operation of idling a fixing device in a non-heating state in which energization to a heater is stopped until a detected temperature in a sheet non-passing portion in a case where a small-sized recording material is used drops to a predetermined temperature after heating processing of the small-sized recording material.

Japanese Patent Application Laid-Open No. 2020-194024 discloses an image forming apparatus including a fixing portion that performs fixing processing of toner transferred to a recording material by applying heat to the recording material at a predetermined fixing temperature, and a temperature controller that corrects the fixing temperature in the fixing processing based on information indicating a toner production time.

Japanese Patent Application Laid-Open No. 2011-59173 discloses a configuration in which a separation claw that separates a recording material from a surface of a fixing film is provided in a fixing device including the fixing film and a pressure roller that abuts on the fixing film to form a nip portion.

### SUMMARY

An image forming apparatus includes a fixing portion including a heating member, a fixing rotating member heated by the heating member, and a pressure rotating member configured to abut on the fixing rotating member to form a nip portion, a temperature detection portion configured to detect a temperature of the fixing rotating member or the heating member, a fixing cooling portion configured to cool the fixing rotating member or the pressure rotating member, a controller configured to perform a fixing operation in which, in a first region where a recording material passes through the nip portion, the recording material passes through a second region having a smaller length in a width direction orthogonal to a conveyance direction of the recording material than the first region of the nip portion, and then performs a cooling operation using the fixing cooling portion until a temperature of a region through which outside the second region in the first region of the nip portion reaches a preset setting temperature, and a storage portion that stores characteristic information of a contained toner, in which at the time of performing the cooling operation using the fixing cooling portion, the setting temperature is corrected based on the characteristic information of the toner stored in the storage portion, and the cooling operation using the fixing cooling portion is performed until the temperature of the region through which outside the second region in the first region of the nip portion reaches the corrected setting temperature.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional configuration diagram of an image forming apparatus;

FIG. 2 is a control block diagram of the image forming apparatus;

FIG. 3 is a cross-sectional configuration diagram of a fixing device;

FIG. 4 is a schematic cross-sectional view of a fixing device and a cooling mechanism;

FIG. 5 is a diagram illustrating a driving configuration of a shutter;

FIG. 6 is a diagram illustrating driving of the shutter;

FIG. 7 is a diagram illustrating driving of the shutter;

FIG. 8 is a diagram illustrating a hot offset toner amount for each basis weight of a recording material;

FIG. 9 is a flowchart illustrating a size mixed cooling operation in Comparative Example 1;

FIG. 10 is a flowchart illustrating a size mixed cooling operation in a first embodiment;

FIG. 11 is a diagram illustrating temperature transition of a size mixed cooling operation in Comparative Example 1;

FIG. 12 is a diagram illustrating temperature transition of a size mixed cooling operation in the first embodiment;

FIG. 13A is a table illustrating a relationship between a toner characteristic value and a correction amount of temperature, and FIG. 13B is a table illustrating cooling operation times of Comparative Example 1 and the first embodiment;

FIG. 14 is a flowchart illustrating a post-rotation cooling operation in Comparative Example 2;

FIG. 15 is a flowchart illustrating a post-rotation cooling operation in a second embodiment;

FIG. 16 is a diagram illustrating temperature transition of the post-rotation cooling operation in Comparative Example 2;

FIG. 17 is a diagram illustrating temperature transition of a post-rotation cooling operation in the second embodiment;

FIG. 18 is a flowchart illustrating a productivity lowering operation in Comparative Example 3;

FIG. 19 is a flowchart illustrating a productivity lowering operation in a third embodiment;

FIG. 20A is a table illustrating a relationship between a toner characteristic value and a correction amount of temperature, and FIG. 20B is a table illustrating operation times of Comparative Example 3 and the third embodiment;

FIG. 21 is a control flowchart of an image forming apparatus according to a seventh embodiment;

FIGS. 22A and 22B are tables illustrating a relationship between a toner characteristic value and a correction amount of a fixing temperature;

FIG. 23 is a control flowchart of an image forming apparatus according to a fifth embodiment;

FIG. 24 is a table illustrating a design for securing separation performance;

FIG. 25 is a table illustrating a design for achieving power consumption reduction based on toner characteristic values;

FIG. 26 is a diagram illustrating a relationship between a toner temperature and a toner viscosity;

FIG. 27 is a diagram illustrating a relationship between a wax content and a separable temperature;

FIG. 28 is a control flowchart of an image forming apparatus according to a sixth embodiment;

FIG. 29 is a table illustrating a correction amount of a fixing temperature in the sixth embodiment;

FIG. 30 is a table illustrating effects in a case where the sixth embodiment is performed; and

FIG. 31 is a control flowchart of an image forming apparatus according to the seventh embodiment.

### DESCRIPTION OF THE EMBODIMENTS

Hereinafter, embodiments of the present disclosure will be described with reference to the drawings. However, dimensions, materials, shapes, relative arrangements, and the like of the components described below are merely examples, and the scope of the present disclosure is not intended to be limited thereto.

### First Embodiment

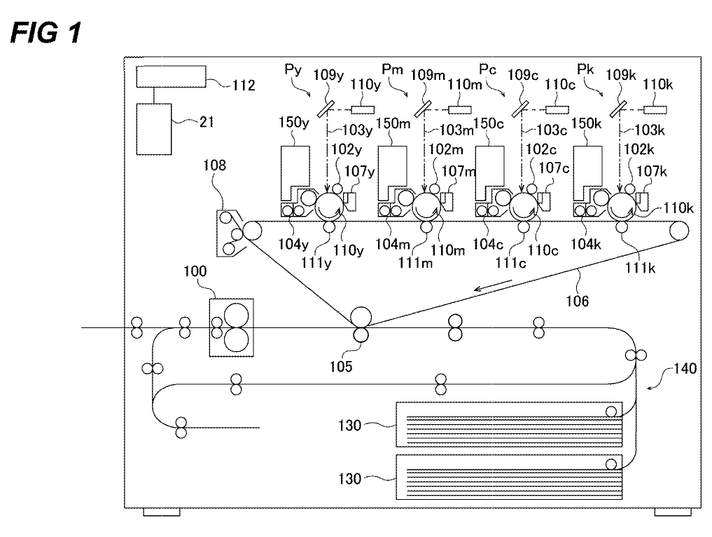

An image forming apparatus will be described with reference to FIG. 1. Here, a color laser beam printer which is an image forming apparatus that forms an image using an electrophotographic process will be described as an example. FIG. 1 is a cross-sectional configuration diagram of a color laser beam printer.

### Image Forming Portion

The image forming apparatus includes image forming portions Py, Pm, Pc, and Pk. The image forming portions Py, Pm, Pc, and Pk form toner images of yellow, magenta, cyan, and black on an intermediate transfer member 105, respectively. Note that, since the image forming portions Py, Pm, Pc, and Pk have the same configuration except that the colors of the toners are different, the yellow image forming portion Py will be described below as an example.

A photosensitive drum 101y as an image bearing member is rotationally driven at a predetermined process speed (circumferential velocity) in a direction of an arrow. The photosensitive drum 101y is charged to have a predetermined polarity by a charging device 102y such as a charging roller during the rotation process.

Next, exposure processing based on input image information is performed on the charged surface of the photosensitive drum 101y by laser light 103y output from a laser optical system 110y. The laser optical system 110y outputs the laser light 103y modulated (on/off) according to a time-series electrical digital pixel signal of target image information from an image signal generation device such as an image reading device (not illustrated) to scan and expose the surface of the photosensitive drum 101y. As a result, an electrostatic latent image corresponding to image information is formed on the surface of the photosensitive drum 101y through this scanning exposure. A mirror 109y deflects the laser light 103y from the laser optical system 110y to an exposure position of the photosensitive drum 101y.

The electrostatic latent image formed on the photosensitive drum 101y is generated as a visible image with the yellow toner by a developing device 104y. The yellow toner image is transferred to the intermediate transfer member 105 at a primary transfer portion 111y which is a contact portion between the photosensitive drum 101y and the intermediate transfer member 105. The toner remaining on the photosensitive drum 101y is cleaned by a cleaner 107y.

The cycle of charging, exposure, development, primary transfer, and drum cleaning described above is also performed in the image forming portions Pm, Pc, and Pk. As a result, a magenta toner image, a cyan toner image, and a black toner image are formed on the intermediate transfer member 105. The multicolor toner images formed in a sequentially superimposed manner on the intermediate transfer member 105 are collectively secondarily transferred onto the recording material in a secondary transfer portion 106.

The toner remaining on the intermediate transfer member 105 is cleaned by a cleaner 108. Further, when a printing instruction is received, the recording material accommodated in the sheet feeding cassette 130 is conveyed to immediately before the secondary transfer portion 106 by a conveying portion 140 and is on standby. A toner image is formed on the recording material in synchronization with the toner image formed on the intermediate transfer member 105.

The recording material having passed through the secondary transfer portion 106 is introduced into the fixing device 100, and undergoes fixing processing (image heating processing) of the unfixed toner image borne on the recording material. The recording material subjected to the fixing processing is discharged to a sheet discharge tray, and a series of image forming operations is ended.

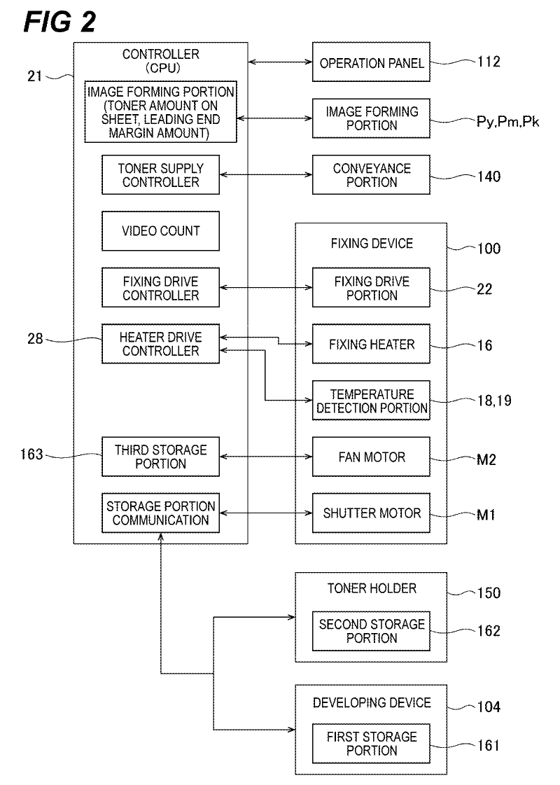

Furthermore, as illustrated in FIG. 2, the image forming apparatus is provided with a controller 21 typified by a CPU or the like, and an operation panel 112 serving as an interface used for communication with a user or an external device and device access. The controller 21 monitors and controls states of various parts in the apparatus including the image forming portions Py, Pm, Pc, and Pk, the recording material conveying portion 140, and the fixing device 100, and totally manages instruction systems between the respective devices to integrate operations of the entire image forming apparatus.

### Developing Device and Toner Bottle

The developing device 104 is a developing portion that develops a latent image formed on the photosensitive drum 101 with toner. The toner bottle 150 is a toner containing portion that contains toner to be supplied to the developing device 104. The toner bottle 150 is detachably attached to the image forming apparatus. The toner bottle 150 is attached to the image forming apparatus, and is connected to the developing device 104 so that toner can be supplied to the developing device 104.

The toner of the developing device 104 is consumed every time the electrostatic latent image formed on the photosensitive drum 101 is generated as a visible image. In this case, in the image forming apparatus, a toner usage amount estimating unit estimates the amount of toner consumed from the developing device 104, and when a predetermined condition is satisfied, the toner is supplied from the toner bottle 150 to the developing device 104. As a result, the toner amount of the developing device 104 is maintained at a substantially constant amount.

The image forming apparatus includes a storage portion that stores characteristic information of the contained toner. The developing device 104 includes a first storage portion 161 that stores characteristic information of the toner stored in the developing device 104 as the storage portion. The first storage portion 161 is provided in the developing device 104, and stores the melting characteristics (characteristics related to a hot offset) of the toner stored in the developing device 104.

In addition, the toner bottle 150 includes, as a storage portion, a second storage portion 162 that stores characteristic information of the toner contained in the toner bottle 150. The second storage portion 162 is provided in the toner bottle 150, and stores melting characteristics (characteristics related to hot offset) of the toner stored in the toner bottle 150.

Here, a nonvolatile memory such as an NVRAM is adopted as the storage portion, but the storage portion is not limited thereto, and may be in the form of, for example, an IC tag such as RFID or a two-dimensional code.

The melting characteristics of the toner (characteristics related to a hot offset) stored in the first storage portion 161 and the second storage portion 162 are values necessary for determining a cooling operation condition of a fixing rotating member that will be described later and a print output speed. The melting characteristics of the toner as the toner characteristic information stored in the storage portion are toner characteristic values related to a temperature for melting the toner. Hereinafter, the melting characteristics of the toner stored in the first storage portion 161 will be referred to as a toner characteristic value T1, and the melting characteristics of the toner stored in the second storage portion 162 will be referred to as a toner characteristic value T2.

In addition, the toner characteristic value T1 stored in the first storage portion 161 and the toner characteristic value T2 stored in the second storage portion 162 are read by the image forming apparatus side, sent to the controller 21, and used to control the cooling operation. The toner characteristic value T1 is a value that is updated as appropriate from the values of the toner supply amount and the toner characteristic value T2.

### Fixing Device

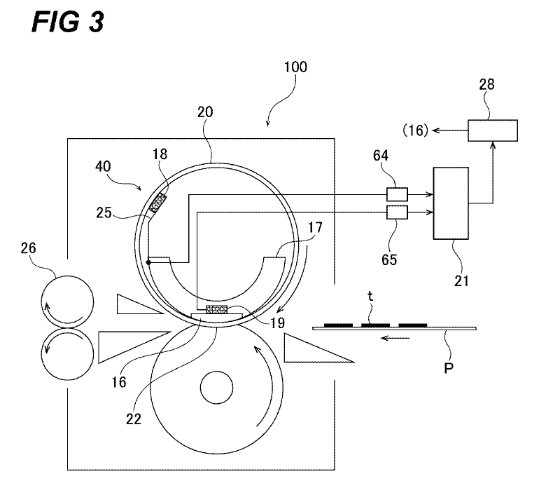

The fixing device 100 will be described with reference to FIG. 3. FIG. 3 is a cross-sectional configuration diagram of the fixing device 100.

The fixing device 100 serving as a fixing portion includes a heater 16 serving as a heating member, a fixing belt 20 serving as a fixing rotating member heated by the heater 16, and a pressure roller 22 serving as a pressure rotating member that abuts on the fixing belt 20 to form a nip portion 27.

The heater 16 is a heating member that heats the fixing belt 20. A heater holder 17 is a holding portion that holds the heater 16, has a cross-sectional shape of a substantially gutter shape, and has heat resistance. The heater 16 is bonded and fixed to the lower surface of the heater holder 17 in the longitudinal direction, and is configured to be slidable with the inner circumferential surface of the fixing belt 20.

The fixing belt 20 is a cylindrical endless belt including an elastic layer. In the fixing belt 20, a silicone rubber layer (elastic layer) having a thickness of about 300 μm is formed on a cylindrical base material formed in cylindrical stainless steel having a thickness of about 30 μm. An outer surface of the elastic layer is coated with a PFA resin tube. The PFA resin tube is a surface layer of the fixing belt 20 and has a thickness of about 30 μm. The fixing belt 20 is externally fitted around the heater holder 17.

The pressure roller 22 abuts on the fixing belt 20 to form the nip portion 27. The pressure roller 22 has a structure in which a silicone rubber layer having a thickness of about 2.5 mm and a PFA resin tube having a thickness of about 50 μm are stacked on a Fe core metal surface. Both ends of the core metal of the pressure roller 22 are rotatably held between both side plates of the fixing device 100. The pressure roller 22 is connected to a motor and rotationally driven. Further, when the pressure roller 22 is rotationally driven, the fixing belt 20 is driven to rotate.

The fixing device 100 is provided with a heating unit 40 including the heater 16, the heater holder 17, and the fixing belt 20. The fixing belt 20 of the heating unit 40 is disposed to be parallel to the pressure roller 22. The heating unit 40 is configured to apply heat necessary for fixing to the recording material.

The heater holder 17 is made of a liquid crystal polymer resin having high heat resistance, and serves to hold the heater 16 and guide the circumferential orbit of the fixing belt 20. Both ends of the heater holder 17 are biased in the rotational axis direction of the pressure roller 22 by a pressure mechanism (not illustrated) with a force of a total pressure of 314 N including 157 N on each side. As a result, the heater 16 is caused to abut on the elastic layer of the pressure roller 22 via the fixing belt 20 with a predetermined pressing force to form the nip portion 27 having a predetermined width necessary for fixing.

The heater 16 includes a resistive heat generator in which a conductive paste containing a silver-palladium alloy is applied in a film shape having a uniform thickness of about 10 μm on a ceramic substrate made of alumina or aluminum nitride by using a screen printing method. Furthermore, a glass coat is applied on the resistive heat generator in order to ensure a pressure resistance.

The fixing device 100 includes temperature detection portions 18 and 19 that detect a temperature. The temperature detection portions 18 and 19 detect the temperature of the passage region through which the recording material passes in the width direction of the recording material orthogonal to the conveyance direction of the recording material. The temperature detection portions 18 and 19 detect the temperature of the heating unit 40. The detected temperatures detected by the temperature detection portions 18 and 19 are used to control the fixing belt 20 to a target temperature. In addition, when the temperature detection portions 18 and 19 detect an excessive temperature rise, this is determined as an error and used for control to interrupt a print job, and the like.

The temperature detection portion 18 detects the temperature of the fixing belt 20. The temperature detection portion 19 detects the temperature of the heater 16. Here, thermistors are exemplified as the temperature detection portions 18 and 19. The temperature detection portion 18 is a belt-back thermistor that detects the temperature of the inner circumferential surface of the fixing belt 20. The temperature detection portion 19 is a heater-back thermistor that detects the temperature of the back surface (the surface opposite to the surface sliding on the fixing belt 20) of the heater 16.

The temperature detection portion 18 is installed to elastically contact the inner circumferential surface of the fixing belt 20, and detects the inner surface temperature of the fixing belt 20. Specifically, the temperature detection portion 18 is attached to a distal end of a stainless steel arm 25 fixedly supported by the heater holder 17. The temperature detection portion 18 keeps a state of being always in contact with the inner surface of the fixing belt 20 due to the elastic swing of the arm 25.

The temperature detection portion 19 and the temperature detection portion 18 are connected to the controller (CPU) 21 via A/D converters 64 and 65, respectively. The controller 21 is configured to sample the output (temperature information) from each of the temperature detection portions 18 and 19 at a predetermined cycle, and reflect the obtained temperature information in the temperature control. That is, the controller 21 determines the temperature adjustment control content of the heater 16 based on the outputs of the temperature detection portion 18 and the temperature detection portion 19, and controls the energization of the heater 16 using a heater drive controller 28 which is a power supply portion.

In the temperature adjustment control method of the fixing device 100, a supply power value to the heater 16 is mainly determined so that the detected temperature value of the temperature detection portion 18 can be stably maintained at a desired temperature. Specifically, the supply power value is calculated from the target temperature, the detected temperature, and the temperature change amount per unit time of the temperature detection portion 18, the heater input power value, and the PI control parameter. As a result, the fixing belt 20 reaches the target temperature early, and the temperature of the fixing belt 20 can be stably maintained. In this case, since a direct heating source is the heater 16, the temperature detected by the temperature detection portion 19 and the temperature change amount are also supplementarily PI-controlled so that the temperature of the fixing belt 20 does not vary too rapidly. As a result, the inner surface temperature of the fixing belt 20 is stabilized at an earlier stage.

Here, the configuration in which the temperature is detected by using the temperature detection portions 18 and 19 is exemplified, but the present invention is not limited thereto. The temperature may be detected by using either the temperature detection portion 18 that detects the temperature of the fixing belt 20 or the temperature detection portion 19 that detects the temperature of the heater 16.

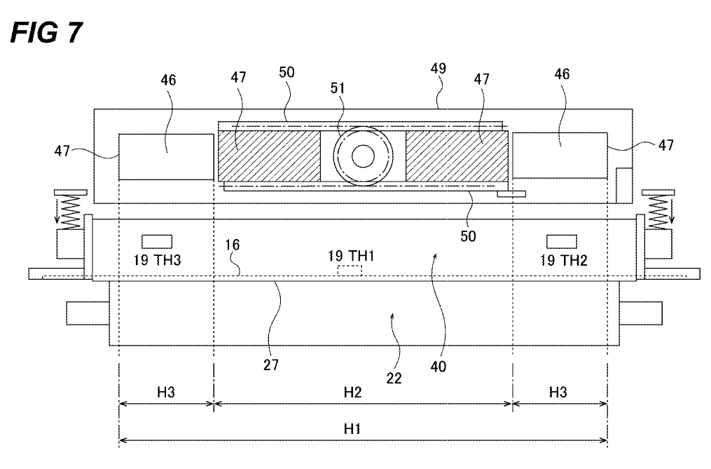

The temperature detection portions 19 are disposed at a plurality of locations in the width direction orthogonal to the recording material conveyance direction of the fixing belt 20. Here, as illustrated in FIG. 7, a configuration is exemplified in which the temperature detection portions 19 are disposed at a total of three locations including one location at the center in the width direction and one location on each side. The temperature detection portion 19 (TH1) at the center in the width direction is disposed at the center of a first region H1 where the recording material passes through the nip portion 27 and a second region H2 where the length in the width direction is smaller than the first region H1 of the nip portion 27. The temperature detection portions 19 (TH2) and 19 (TH3) on both sides in the width direction are disposed in a sheet non-passing region H3 where the recording material outside the second region H2 in the first region H1 of the nip portion 27 does not pass.

Here, a configuration in which a plurality of temperature detection portions 19 is disposed in the width direction is exemplified, but the present invention is not limited thereto. A plurality of temperature detection portions 18 may be disposed in the width direction, or a plurality of temperature detection portions 18 and 19 may be disposed in the width direction.

When the image forming operation is started, the pressure roller 22 is rotationally driven at a predetermined circumferential velocity in a direction of an arrow in FIG. 3. The fixing belt 20 that abuts on the pressure roller 22 and forms the nip portion 27 is driven by the pressure roller 22 and rotates at a predetermined speed. In this case, the inner circumferential surface of the fixing belt 20 is in close contact with the sliding surface of the heater 16 to slide, and the outer periphery of the heater holder 17 is in a driven rotation state in the direction of the arrow. Heat resistant grease is applied to the inner surface of the fixing belt 20 to ensure slidability between the heater holder 17 and the inner surface of the fixing belt 20.

When the pressure roller 22 is rotationally driven and the cylindrical fixing belt 20 is in a driven rotation state accordingly, the heater 16 is energized. When the fixing belt 20 reaches the target temperature, the recording material bearing an unfixed toner image T is guided along an inlet guide 23 and introduced into the nip portion 27.

In the nip portion 27, the toner image bearing surface side of the recording material is in close contact with the outer circumferential surface of the fixing belt 20, and the recording material moves together with the fixing belt 20. In the process of nipping and conveying the recording material in the nip portion 27, the heat of the fixing belt 20 is applied to the recording material, and the unfixed toner image is melted and fixed onto the recording material. The recording material having passed through the nip portion 27 is separated from the fixing belt 20 and discharged by a fixing discharge roller 26.

### Cooling Mechanism

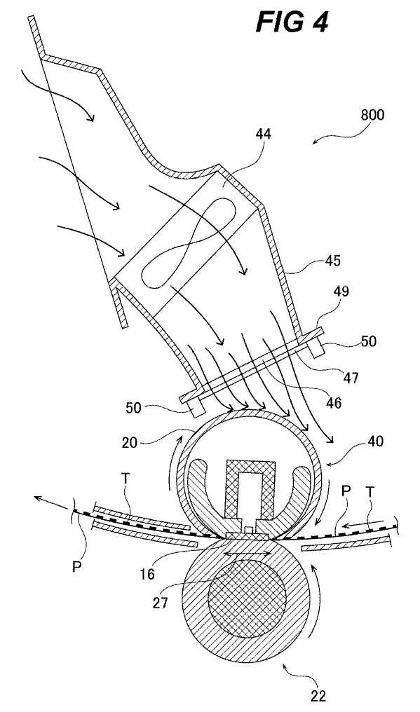

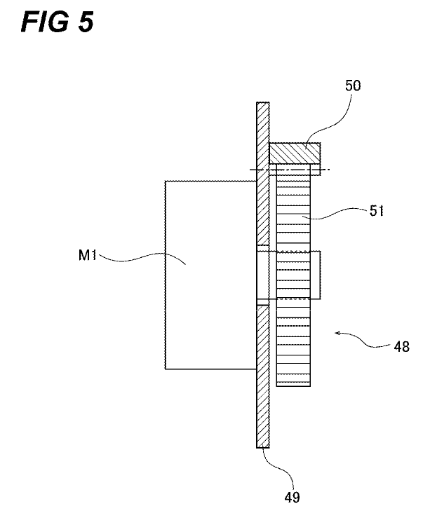

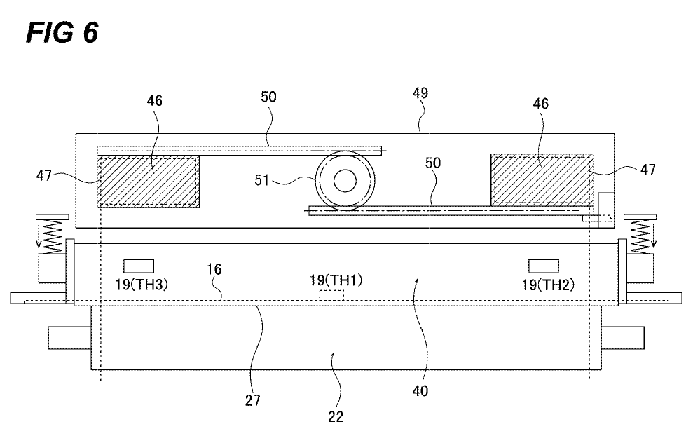

A cooling mechanism 800 will be described with reference to FIGS. 4, 5, 6, and 7. FIG. 4 is a schematic cross-sectional view of the fixing device 100 and the cooling mechanism 800. FIG. 5 is a diagram illustrating a configuration of driving a shutter. FIG. 6 is a diagram illustrating driving of the shutter, and is a diagram illustrating a state in which an opening portion is closed by the shutter. FIG. 7 is a diagram illustrating driving of the shutter, and is a diagram illustrating a state in which the opening portion is opened by the shutter.

The image forming apparatus includes the cooling mechanism 800 serving as a fixing cooling portion that cools the fixing belt 20. Here, the cooling mechanism 800 that cools the fixing belt 20 is exemplified as a fixing cooling portion, but the fixing cooling portion is not limited thereto, and may be, for example, a fixing cooling portion that cools the pressure roller 22.

As illustrated in FIG. 4, the cooling mechanism 800 is provided to suppress the temperature rise of the sheet non-passing region of the fixing belt 20, which occurs when the small-sized recording material is continuously subjected to the fixing processing, through cooling (blowing).

Here, as illustrated in FIG. 7, the sheet non-passing region H3 of the fixing belt 20 is a region through which the recording material does not pass outside the second region H2 in the first region H1 of the nip portion 27 in the width direction orthogonal to the conveyance direction of the recording material. Here, the first region H1 of the nip portion 27 is a region through which the recording material having the maximum size in the width direction passes. The second region H2 is a region through which a small-sized recording material having a smaller length in the width direction than the first region H1 of the nip portion 27 passes. That is, the sheet non-passing region H3 is a region through which the recording material having the small size does not pass outside the second region in the first region H1 through which the recording material having the maximum size passes.

FIG. 7 illustrates a state in which the opening portion 46 outside the second region H2 in the first region H1 of the nip portion 27 is fully opened. In this case, a region corresponding to a portion where the opening portion 46 is opened is the sheet non-passing region H3 through which the recording material does not pass. However, the sheet non-passing region H3 through which the recording material does not pass is not limited thereto. In a case where only a part of the opening portion 46 is opened by the shutter 47, a region corresponding to a portion where the opening portion 46 is opened is the sheet non-passing region H3 through which the recording material does not pass. Furthermore, the first region H1 of the nip portion 27 is not limited to a region through which the recording material having the maximum size passes, and it goes without saying that a region through which the recording material having a larger size in the width direction than the second region H2 passes is the first region H1 in the nip portion 27.

The cooling mechanism 800 includes a fan 44 and a duct 45 that guides wind (air) generated by the fan 44. The duct 45 has the opening portion 46, and the opening portion 46 is provided at a position facing an end of the fixing belt 20 that becomes a sheet non-passing region when fixing processing is performed on a small-sized recording material. The wind generated by the fan 44 is guided to the end of the fixing belt 20 through the opening portion 46. The cooling mechanism 800 includes the shutter 47 serving as an adjustment member that adjusts the opening width of the opening portion 46 according to the width of the recording material to be used, and a shutter drive portion 48 (see FIG. 5) that drives the shutter 47.

The fan 44, the duct 45, the opening portion 46, and the shutter 47 are disposed to be horizontally symmetric with respect to the center in the width direction of the fixing belt 20. Here, although an axial fan is used as the fan 44, the fan is not limited thereto, and for example, a centrifugal fan such as a sirocco fan may be used.

Here, a drive configuration of the shutter 47 will be described. As illustrated in FIG. 5, the shutter drive portion 48 includes a support plate 49, a rack teeth 50, a pinion gear 51, and a shutter motor M1. The two left and right shutters 47 are supported to be slidable in the left-right direction along the plate surface of the support plate 49 forming the opening portion 46 and extending in the left-right direction. The shutter 47 is communicated with the rack teeth 50 by the pinion gear 51, and the pinion gear 51 is rotated forward and backward by forward and reverse driving of the shutter motor (pulse motor) M1. As a result, the left and right shutters 47 are opened and closed in a horizontally symmetrical relationship with respect to the corresponding opening portions 46 in conjunction with each other.

The left and right opening portions 46 are provided from a position slightly closer to the center than the sheet non-passing region generated when the recording material having the smallest size in the width direction passes to the sheet passing width of the recording material having the maximum size. The left and right shutters 47 are disposed in such a direction as to close the opening portion 46 by a predetermined amount from the center to the end in the longitudinal direction of the support plate 49.

When the width information of the recording material is the recording material having the maximum size, the controller 21 controls the shutter drive portion 48 to move the shutter 47 to the fully closed position where the opening portion 46 is closed by the shutter 47 as illustrated in FIG. 6. Further, when the recording material has a small size of the A4 vertical feeding size width, the shutter 47 is moved to the fully open position where the opening portion 46 is opened as illustrated in FIG. 7. As the position information of the shutter 47, a flag (not illustrated) disposed at a predetermined position of the shutter 47 is detected by a sensor (not illustrated) disposed on the support plate 49. Specifically, as illustrated in FIG. 6, the home position is set at the shutter position where the opening portion 46 is fully closed, and the opening amount is detected from the rotation amount of the shutter motor M1.

In addition, the controller 21 controls the fan motor M2 according to the output results of the temperature detection portion 19 (TH2) and the temperature detection portion 19 (TH3) disposed in the respective sheet non-passing regions H3, and the cooling operation using the fan 44 is performed. The cooling operation using the fan 44 is not limited to an operation performed during the fixing processing of the recording material. In a case where the temperature of the sheet non-passing region H3 is high after the fixing processing of the small-sized recording material, the cooling operation using the cooling mechanism 800 is performed until the end portion temperature becomes equal to or lower than a predetermined temperature so that a hot offset does not occur in the sheet passing region of the subsequent large-sized recording material.

### Relationship between Temperature of Fixing Device and Offset Toner Amount

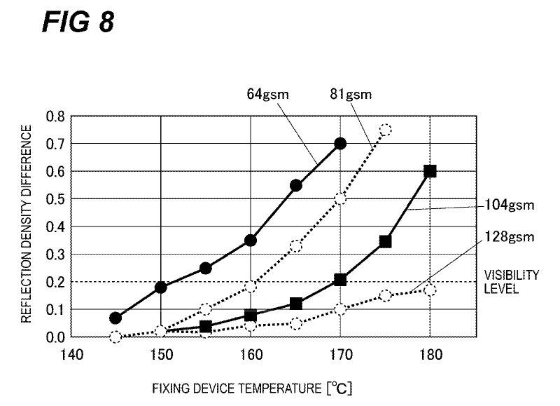

A relationship between the temperature of the fixing device and a hot offset toner amount will be described with reference to FIG. 8. FIG. 8 is a diagram of an experimental result illustrating the relationship between the hot offset toner amount and the temperature of the fixing device.

The basis weights of the recording materials used in the experiment of FIG. 8 are four types of 64 gsm, 81 gsm, 104 gsm, and 128 gsm. The recording material was conveyed at a conveyance speed of 300 mm/sec. In this experiment, the temperature of the fixing device is changed in increments of 5°C in the range of 145°C to 180°C, and the recording material on which the unfixed toner image is placed is caused to pass through the fixing device 100.

The reflection density difference was used to quantify the amount of the offset toner reattached to the subsequent recording material (hot offset toner amount). The reflection density difference is obtained by measuring the reflection density of the toner reattachment portion and the white background portion of the recording material with a reflection densitometer and quantifying the difference as a reflection density difference. It is considered that the larger the value of the reflection density difference, the larger the amount of reattached offset toner. For the measurement, a reflection densitometer, Tokyo Denshoku TC-6MC-D, was used.

A visibility level in FIG. 8 is a level at which a portion where the offset toner is reattached to the subsequent recording material can be visually recognized. When the offset toner amount exceeding the visibility level is generated, there is a possibility that an image defect occurs in a subsequent recording material. Therefore, it is required not to exceed the reflection density difference of 0.2 in image formation.

As illustrated in FIG. 8, as the temperature of the fixing device 100 increases, the reflection density difference increases. Furthermore, the reflection density difference increases as the basis weight of the recording material decreases.

In a case where a recording material having a basis weight of 64 gsm is caused to pass through the fixing device 100, image defects due to the hot offset can be suppressed by setting the fixing temperature to 150°C or lower. Similarly, in a case where recording materials having basis weights of 81, 104, and 128 gsm are caused to pass through the fixing device 100, image defects due to the hot offset can be suppressed by setting the fixing temperatures to 160°C, 165°C, and 170°C or lower, respectively. That is, the image defect due to the hot offset can be suppressed by setting the fixing temperature to a higher temperature as the basis weight of the recording material becomes smaller.

### Cooling Operation Flow of Size Mixed Job

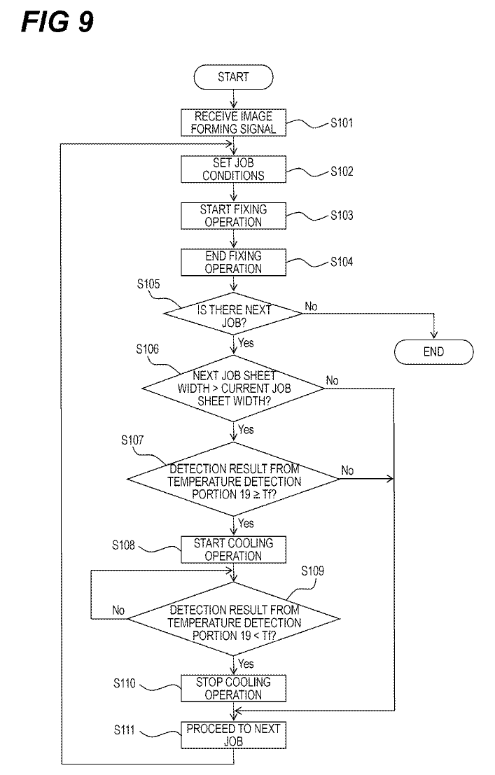

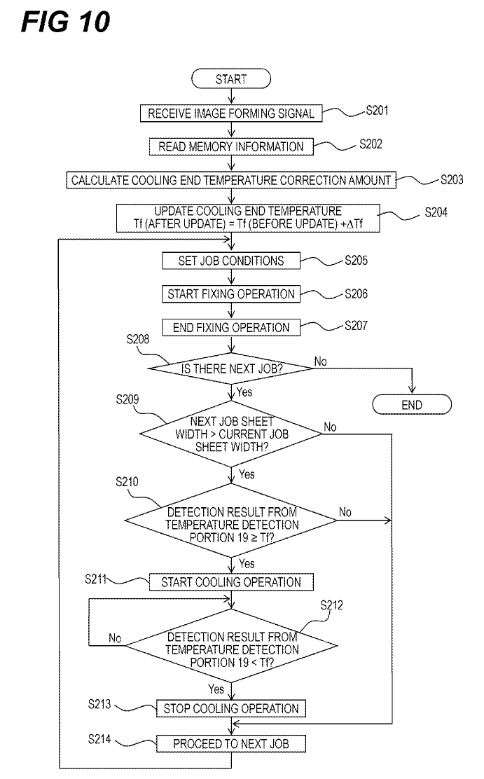

Here, a cooling operation flow of the size mixed job of the first embodiment illustrated in FIG. 10 will be described in comparison with Comparative Example 1 illustrated in FIG. 9. The size mixed job is a job in which a job of a recording material having a first size and a job of a recording material having a second size having a smaller length in the width direction orthogonal to the conveyance direction than the recording material having the first size are coupled. For example, in FIG. 7, a job in which a job of a recording material having the first size passing through the first region H1 and a job of a recording material having the second size passing through the second region H2 are coupled is a size mixed job.

### Cooling Operation Flow of Comparative Example 1

First, a cooling operation flow of a size mixed job of Comparative Example 1 will be described with reference to FIG. 9.

FIG. 9 is a flowchart illustrating the cooling operation of the size mixed job in Comparative Example 1.

In the first region H1 of the nip portion 27 through which the recording material having the maximum size passes, the controller 21 performs the following cooling operation after performing the fixing operation in which the recording material having the small size passes through the second region H2 having a smaller length in the width direction than the first region H1. That is, the controller 21 causes the cooling mechanism 800 to perform the cooling operation until the temperature of the sheet non-passing region H3 through which the small-sized recording material does not pass outside the second region H2 in the first region H1 of the nip portion 27 reaches a cooling end temperature Tf that is a preset setting temperature. This will be described in detail with reference to FIG. 9.

In Comparative Example 1 illustrated in FIG. 9, upon receiving an image forming signal (S101), the controller 21 sets job conditions (S102), and the fixing operation is started (S103). After the print operation is ended, the fixing operation is ended (S104).

When there is the next job after the end of the fixing operation (Yes in S105), the sheet width of the next job (the size of the recording material in the width direction) is compared with the sheet width of the current job (S106). When the sheet width of the next job is equal to the sheet width of the current job or smaller than the sheet width of the current job (No in S106), the processing proceeds to the next job (S111). When the sheet width of the next job is larger than the sheet width of the current job (Yes in S106), the temperature detection portion 19 determines the end portion temperature of the fixing belt 20 (S107). Here, the end portion temperature of the fixing belt 20 is the temperature of the sheet non-passing region H3 illustrated in FIG. 7.

Here, in a case where the end portion temperature of the fixing belt 20 is lower than the preset cooling end temperature Tf (No in S107), the processing proceeds to the next job (S111). On the other hand, in a case where the end portion temperature of the fixing belt 20 is equal to or higher than the preset cooling end temperature Tf (Yes in S107), the cooling operation using the cooling mechanism 800 is started (S108).

In Comparative Example 1, the cooling end temperature Tf is uniformly set to a fixed temperature so as not to cause a hot offset even when toner having any toner characteristic value is used. That is, the cooling end temperature Tf, which is the preset setting temperature, is set to a temperature corresponding to the toner characteristic value of the toner that is most likely to be melted in the standard range at the time of manufacturing the toner.

After the cooling operation is started, in a case where the end portion temperature of the fixing belt 20 is lower than the cooling end temperature Tf (No in S109), the cooling operation is continued. When the end portion temperature of the fixing belt 20 becomes lower than the cooling end temperature Tf (Yes in S109), the cooling operation is stopped (S110). After the cooling operation is stopped, the processing proceeds to the next job (S111), and the next job conditions are set (S102). In a case where there is no next job after end of the fixing operation, the job is ended (No in S105).

### Cooling Operation Flow of First Embodiment

Next, a cooling operation flow of the size mixed job of the first embodiment will be described with reference to FIG. 10. FIG. 10 is a flowchart illustrating the cooling operation of the size mixed job according to the first embodiment.

In Comparative Example 1 described above, the cooling end temperature Tf, which is a preset setting temperature, is uniformly set to a fixed temperature. Therefore, when the cooling operation is performed, even if the contained toner is a toner having a toner characteristic value at which a melting temperature is lower than the cooling end temperature Tf, it is necessary to wait for the end of the cooling operation until the toner reaches the cooling end temperature Tf, and the productivity is lowered.

In the first embodiment, when the cooling operation is performed by the cooling mechanism 800, the cooling end temperature Tf that is the setting temperature is corrected based on the characteristic value T1 of the toner stored in the first storage portion 161.

That is, when the cooling operation is performed, the cooling end temperature Tf is corrected to a temperature corresponding to the toner characteristic value of the contained toner. The cooling mechanism 800 performs the cooling operation until the temperature of the sheet non-passing region H3 through which the recording material does not pass outside the second region H2 in the first region H1 of the nip portion 27 reaches the corrected cooling end temperature Tf. This will be described in detail with reference to FIG. 10.

In the first embodiment illustrated in FIG. 10, the controller 21 receives the image forming signal (S201). The controller 21 reads the toner characteristic value T1 serving as the toner melting characteristic stored in the first storage portion 161 (developing device 104) (S202).

The controller 21 derives a correction amount ΔTf corresponding to the toner characteristic value T1 read from the first storage portion 161 (S203). The controller 21 corrects the cooling end temperature Tf, which is an initial value setting temperature that is set in advance for the cooling operation, by using the derived correction amount ΔTf (S204). That is, the controller 21 sets, as the cooling end setting temperature, the updated cooling end temperature Tf obtained by adding the correction amount ΔTf corresponding to the toner characteristic value T1 to the cooling end temperature Tf that is the initial value setting temperature.

For example, the toner characteristic value at the initial value setting temperature (the cooling end temperature Tf before update) that is set in advance is set as a first toner characteristic value. On the other hand, in a case where the toner characteristic value T1 read from the first storage portion 161 is the second toner characteristic value in which the toner is less likely to be melted than the first toner characteristic value, the controller 21 derives a correction amount ΔTf for correcting the setting temperature to be high according to the second toner characteristic value. The controller 21 corrects the cooling end temperature Tf before update, which is the setting temperature, by using the derived correction amount.

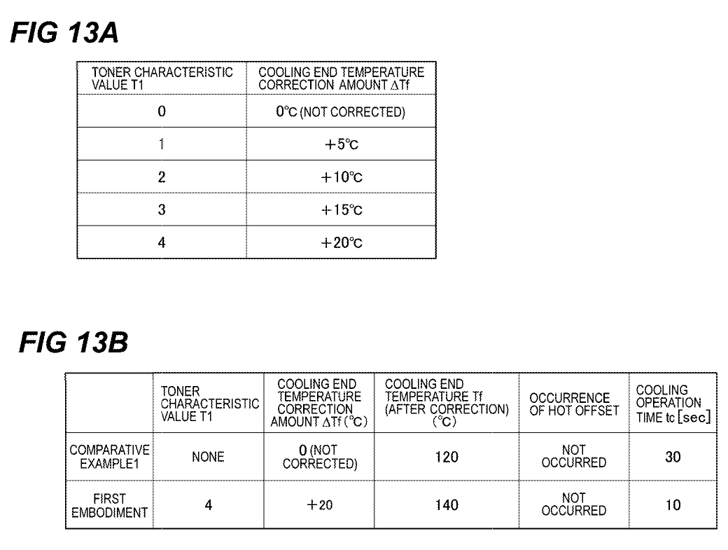

Here, as illustrated in FIG. 13A, the toner characteristic value T1 serving as the toner melting characteristic information is divided into five levels, and 4 is set to the maximum with 0 as a reference, and the toner characteristic value T1 is set to be advantageous with respect to the hot offset as the number increases. That is, the toner characteristic value T1 is set such that the toner is less likely to be melted as the number increases with reference to 0. The correction amount ΔTf for correcting the cooling end temperature Tf, which is the initial value setting temperature, is set to increase as the number (numerical value) of the toner characteristic value T1 increases. The table illustrated in FIG. 13A (the table indicating the relationship between the toner characteristic value T1 and the correction amount ΔTf of the cooling end temperature) is stored in the third storage portion 163 of the controller 21.

As described above, the toner characteristic value T1 stored in the first storage portion 161 is a value that is appropriately updated from the toner characteristic value T2 stored in the second storage portion 162 and the toner supply amount from the toner bottle 150 to the developing device 104.

After correcting the cooling end temperature Tf, the controller 21 sets job conditions (S205) and starts the fixing operation (S206). That is, the controller 21 starts energization to the heater 16, drives the fixing drive motor M to rotate the pressure roller 22, and heats the fixing belt 20. When the fixing belt 20 or the heater 16 reaches the target temperature, passing of the recording material is started (S206). After the print operation is ended, the fixing operation is ended (S207).

In a case where there is the next job after the fixing operation is ended (Yes in S208), the sheet width of the next job (the size of the recording material in the width direction) is compared with the sheet width of the current job (S209). In a case where the sheet width of the next job is equal to the sheet width of the current job or smaller than the sheet width of the current job (No in S209), the processing proceeds to the next job (S214). In a case where the sheet width of the next job is larger than the sheet width of the current job (Yes in S209), the temperature detection portion 19 determines the end portion temperature of the fixing belt 20 (S210).

Here, in a case where the end portion temperature of the fixing belt 20 is lower than the corrected cooling end temperature Tf (No in S210), the processing proceeds to the next job (S214). On the other hand, when the end portion temperature of the fixing belt 20 is equal to or higher than the corrected cooling end temperature Tf (Yes in S210), the cooling operation is started (S211).

After the cooling operation is started, in a case where the end portion temperature of the fixing belt 20 is equal to or higher than the corrected cooling end temperature Tf (No in S212), the cooling operation is continued. On the other hand, in a case where the end portion temperature of the fixing belt 20 becomes lower than the corrected cooling end temperature Tf after the cooling operation is started (Yes in S212), the cooling operation is stopped (S213). After the cooling operation is stopped, the processing proceeds to the next job (S214), and the next job conditions are set (S205). In a case where there is no next job after the fixing operation is ended (No in S208), the job is ended.

As described above, according to the first embodiment, in order to correct the cooling end temperature Tf to the setting temperature according to the characteristic information of the contained toner when the cooling operation is performed, the cooling operation is performed at the optimum operation time according to the characteristic information of the toner. As a result, the waiting time after the fixing operation in which the recording material having a small length in the width direction passes through the nip portion 27 can be shortened, and the productivity can be improved.

### Comparison of Operation between Comparative Example 1 and First Embodiment

The print operations of Comparative Example 1 and the first embodiment were compared under the following conditions.

Print conditions were a main body conveyance speed of 300 mm/s, a print speed of 60 sheets/min, a sheet type: CS064, a temperature adjustment temperature: 150°C, and a cooling end temperature Tf (before update): 120°C. In addition, as job conditions, a size mixed job was executed in which 100 sheets of A5R size recording material passed and then 100 sheets of A4 size recording material passed. As the toner, a toner having low melting characteristics (a toner in which the hot offset is less likely to occur) was used compared with a standard toner in which variation in melting characteristics (characteristic information) can be used within a standard range at the time of manufacture. Here, a case where a toner having the toner characteristic value T1 = 4 is used as a toner having low melting characteristics will be exemplified. Note that, under these conditions, the end portion temperature detected by the temperature detection portion 19 becomes the temperature of the sheet non-passing region in the small-sized recording material (sheet width of A5R size) and increases as the sheet passes, but becomes the temperature of the sheet passing region in the large-sized recording material (sheet width of A4 size) compared with the small-sized recording material and thus decreases as the sheet passes.

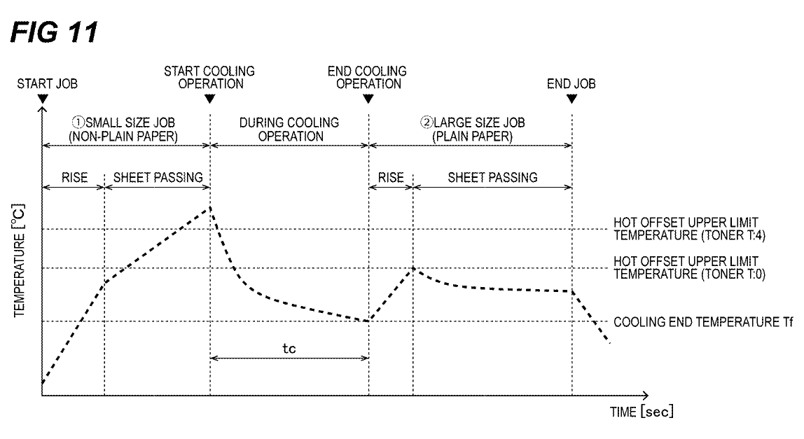

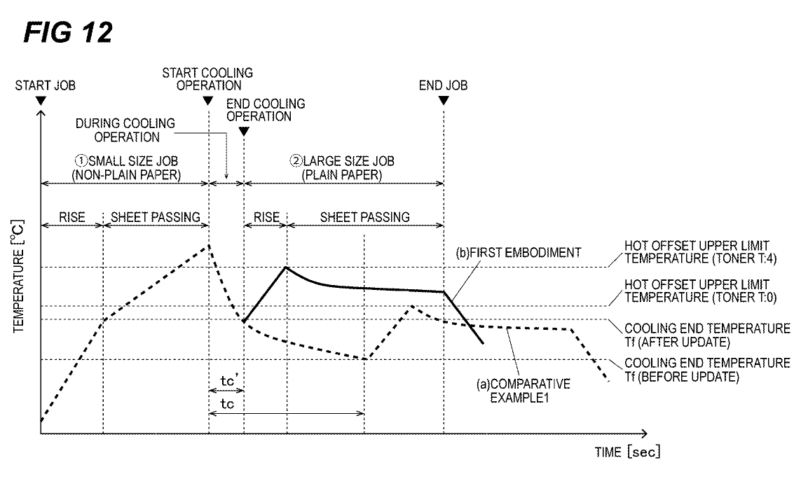

FIGS. 11 and 12 illustrate transition of the end portion temperature detected by the temperature detection portion 19 during operation. FIG. 11 is a diagram illustrating temperature transition of the cooling operation of the size mixed job in Comparative Example 1. FIG. 12 is a diagram illustrating temperature transition of the cooling operation of the size mixed job in the first embodiment.

In Comparative Example 1, as illustrated in FIG. 11, a cooling operation is performed after passage of a small-sized recording material and before passage of a large-sized recording material. After the A5R-sized recording material passes, the cooling operation is performed before the A4-sized recording material passes, which is the next job. As illustrated in the cooling operation flow of FIG. 9, in a case where the end portion temperature exceeds the cooling end temperature Tf, the cooling operation is executed until the end portion temperature falls below the cooling end temperature Tf. In Comparative Example 1, the cooling end temperature Tf is designed to satisfy the image quality standard even for a toner having high melting characteristics (a toner in which the hot offset is likely to occur) within the variation in the standard range, and is uniformly set to the cooling end temperature Tf = 120°C, which is a fixed temperature. After the cooling operation is performed until the cooling end temperature Tf = 120°C, the processing proceeds to the next job of A4 size. In this case, the cooling operation time tc was 30 seconds. In addition, in the next job of A4 size, since the end portion temperature of the sheet passing region was lower than the hot offset upper limit temperature, the hot offset did not occur.

On the other hand, in the first embodiment, as illustrated in FIG. 12, the cooling operation is performed after passage of the small-sized recording material and before passage of the large-sized recording material. As the toner melting characteristics, since the toner characteristic value T1 is 4, the correction amount of the cooling end temperature Tf is +20°C from FIG. 13A. As illustrated in the cooling operation flow of FIG. 10, the toner melting characteristic information is read from the first storage portion 161 that is a memory, and the cooling end temperature Tf is corrected by the correction amount ΔTf corresponding to the read toner characteristic value T1. That is, the temperature is changed to the updated cooling end temperature Tf (120°C + 20°C = 140°C) obtained by adding the correction amount ΔTf to the preset cooling end temperature Tf before update. After the cooling operation is performed until the cooling end temperature Tf = 140°C, the processing proceeds to the next job of A4 size. In this case, the cooling operation time tc’ was 10 seconds. In the next job of A4 size, the end portion temperature of the sheet passing region was lower than the hot offset upper limit temperature, and thus the hot offset did not occur.

FIG. 13B illustrates a comparison result of the print operation. As illustrated in FIG. 13B, it was confirmed that the cooling operation time tc was 30 seconds in the comparative example, whereas the cooling operation time tc’ could be shortened to 10 seconds in the first embodiment. From this, according to the present embodiment, it has been confirmed that the productivity in the size mixed job can be improved without causing the hot offset.

### Second Embodiment

Next, a cooling operation flow of an image forming apparatus according to the second embodiment will be described. Since a schematic configuration of the image forming apparatus is similar to that of the above-described embodiment, the description thereof will be omitted here.

In the above-described embodiment, the cooling operation at the time of size mixture has been described, but the present invention is not limited thereto. That is, the configuration in which the cooling operation is performed after passage of the small-sized recording material and before passage of the large-sized recording material has been exemplified, but the present invention is not limited thereto. For example, similar control can be applied to a post-rotation cooling operation after passage of a small-sized recording material. Even in a case where there is no next job after the passage of the small-sized recording material, there is a possibility that a wider recording material will pass in the next job. Therefore, it is also possible to perform the cooling operation during the post-rotation operation after the end of the job of the small-sized recording material.

### Cooling Operation Flow of Second Embodiment

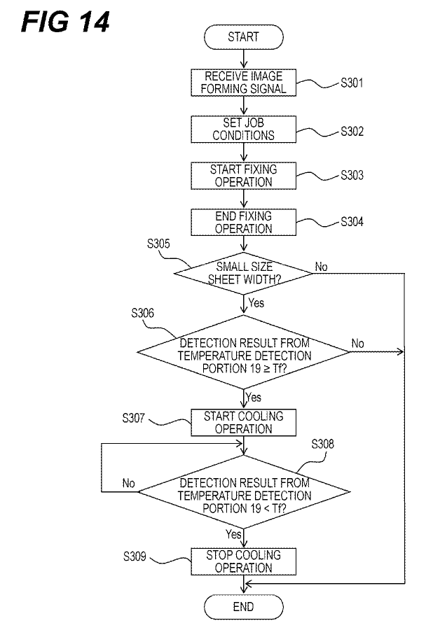

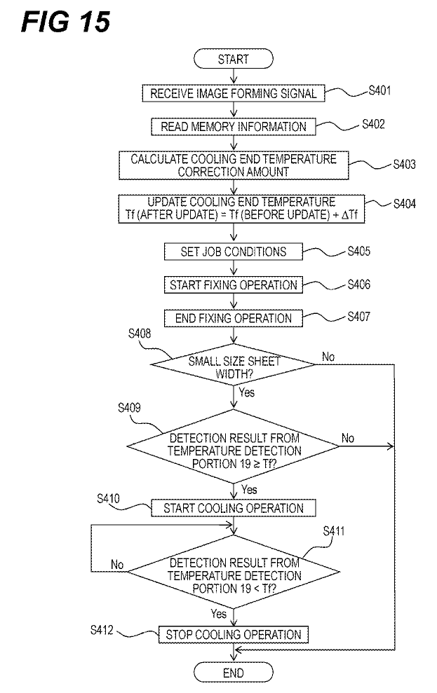

FIG. 14 is a flowchart illustrating a post-rotation cooling operation after passage of a small-sized recording material in Comparative Example 2. FIG. 15 is a flowchart illustrating a post-rotation cooling operation after passage of a small-sized recording material in the second embodiment. A difference from the above-described size mixed job is that post-rotation cooling is performed even in a case where there is no next job after passage of a small-sized recording material.

Note that the control in S301 to S304 and S306 to S309 in the cooling operation flow of Comparative Example 2 illustrated in FIG. 14 is similar to the control in S101 to S104 and S107 to S110 in the cooling operation flow of Comparative Example 1 illustrated in FIG. 9, and thus description thereof will be omitted.

Further, since the control in S401 to S407 and S309 to S412 in the cooling operation flow of the second embodiment illustrated in FIG. 15 is similar to the control in S201 to S207 and S210 to S213 in the cooling operation flow of the first embodiment illustrated in FIG. 10, the description thereof will be omitted.

After the end of the fixing operation, the controller 21 determines whether the size of the recording material of the current job is a small-sized sheet width (S305 in FIG. 14 and S408 in FIG. 15). In the case of the small-sized sheet width, the temperature detection portion 19 determines the end portion temperature of the fixing belt 20 (S306 in FIG. 14 and S409 in FIG. 15). Here, the determination as to whether or not the sheet width is a small-sized sheet width may be made by using a threshold of any determined sheet width such as an A4R size.

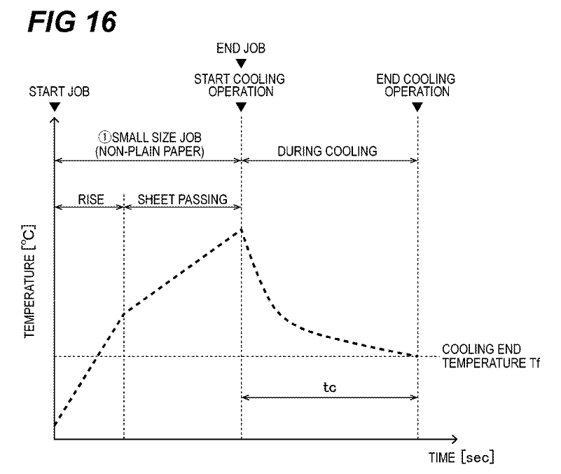

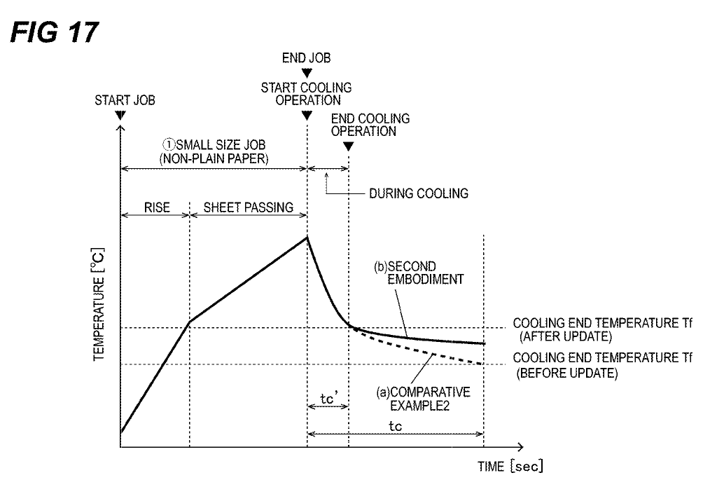

FIGS. 16 and 17 illustrate transition of the end portion temperature detected by the temperature detection portion 19 during operation. FIG. 16 is a graph illustrating temperature transition of the cooling operation during post-rotation in Comparative Example 2. FIG. 12 is a diagram illustrating temperature transition of the cooling operation during post-rotation in the first embodiment.

During the post-rotation cooling, the next job cannot be accepted until the cooling operation is ended. However, since the cooling time of post-rotation after passage of the small-sized recording material is shortened, the next job can be accepted quickly. Therefore, in the present embodiment as well, productivity can be improved similarly to the above-described embodiment. In addition, an effect of improving user’s convenience can be obtained.

### Third Embodiment

Next, an operation flow of an image forming apparatus according to a third embodiment will be described. Since a schematic configuration of the image forming apparatus is similar to that of the above-described embodiment, the description thereof will be omitted here.

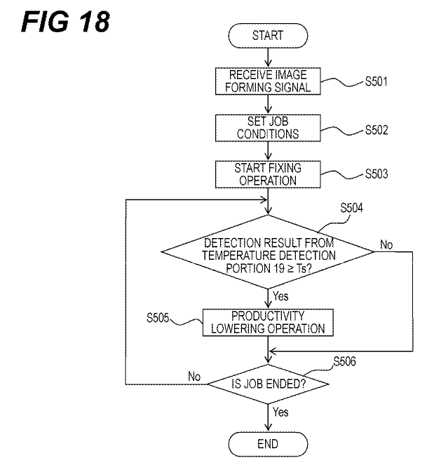

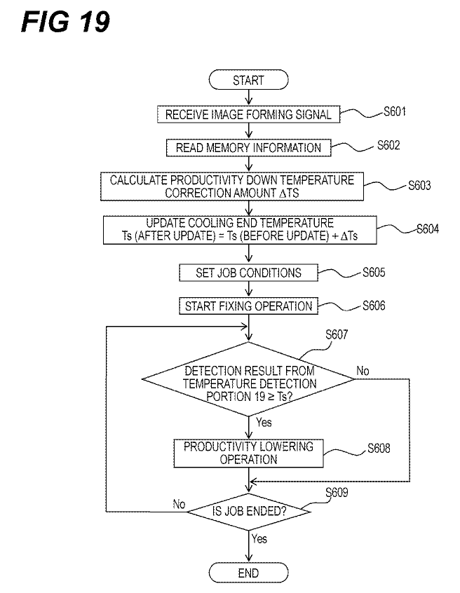

Here, an operation flow of a job of a single size of the third embodiment illustrated in FIG. 19 will be described in comparison with Comparative Example 3 illustrated in FIG. 18. The operation flow in the present embodiment is not an operation flow of a size mixed job but an operation flow of a job of a single size.

### Operation Flow of Comparative Example 3

First, an operation flow of a job of a single size according to Comparative Example 3 will be described with reference to FIG. 18. FIG. 18 is a flowchart illustrating an operation of the job of a single size in Comparative Example 3.

In the first region H1 of the nip portion 27 through which the recording material having the maximum size passes, the controller 21 performs the following operation when performing the fixing operation in which the recording material having the small size passes through the second region H2 having a smaller length in the width direction than the first region H1. That is, in a case where the temperature of the sheet non-passing region H3 through which the small-sized recording material does not pass outside the second region H2 in the first region H1 of the nip portion 27 exceeds a preset setting temperature Ts, the controller 21 performs an operation of lowering the productivity. This will be described in detail with reference to FIG. 18.

In Comparative Example 3 illustrated in FIG. 18, upon receiving an image forming signal (S501), the controller 21 sets job conditions (S502), and the fixing operation is started (S503).

During the print operation, the temperature detection portion 19 determines the end portion temperature of the fixing belt 20 (S504). Here, the end portion temperature of the fixing belt 20 is the temperature of the sheet non-passing region H3 illustrated in FIG. 7.

Here, in a case where the end portion temperature of the fixing belt 20 is lower than the preset setting temperature Ts (No in S504), the job is ended (S606). On the other hand, when the end portion temperature of the fixing belt 20 is equal to or higher than the preset setting temperature Ts (Yes in S604), the operation of lowering the productivity is performed. The amount of lowering productivity is, for example, set to 70% of the productivity before change. Here, as the operation of lowering the productivity, an operation of reducing the number of recording materials passing through the nip portion 27 per time is performed. Alternatively, an operation of reducing the speed of the recording material passing through the nip portion 27 may be performed.

In Comparative Example 3, the setting temperature Ts is set to a unique value so as not to cause an image defect such as a hot offset in the next job. That is, the preset setting temperature Ts is set based on the toner having high melting characteristics in a standard range at the time of manufacturing the toner. Here, the setting temperature Ts is set to 200°C.

As described above, by performing the operation of lowering the productivity under the condition that the temperature rise of the end portion temperature of the fixing belt 20 is severe, the temperature rise of the end portion temperature of the fixing belt 20 is suppressed.

### Operation Flow of Second Embodiment

Next, an operation flow of the job of a single size according to the third embodiment will be described with reference to FIG. 19. FIG. 19 is a flowchart illustrating an operation of a job of a single size in the third embodiment.

In Comparative Example 3 described above, the preset setting temperature Ts is set to a unique value. Therefore, in a case where the productivity lowering operation is performed, even if the contained toner is a toner having a melting temperature lower than the setting temperature Ts, it is necessary to wait for the end of the productivity lowering operation until the temperature reaches the setting temperature Ts, and the productivity has been lowered.

In the third embodiment, when the fixing operation in which the recording material passes through the second region H2 of the nip portion 27 is performed, the setting temperature Ts is corrected based on the characteristic value T1 of the toner stored in the first storage portion 161. That is, when the fixing operation is performed, the setting temperature Ts is corrected to a temperature corresponding to the toner characteristic value of the contained toner. In a case where the temperature of the sheet non-passing region H3 through which the recording material does not pass outside the second region H2 in the first region H1 of the nip portion 27 exceeds the corrected setting temperature Ts, the operation of lowering the productivity is performed. This will be described in detail with reference to FIG. 10.

In the third embodiment illustrated in FIG. 19, the controller 21 receives an image forming signal (S601). The controller 21 reads the toner characteristic value T1 serving as toner melting characteristic information stored in the first storage portion 161 (developing device 104) (S602).

The controller 21 derives the correction amount ΔTs corresponding to the toner characteristic value T1 read from the first storage portion 161 (S603). The controller 21 corrects the setting temperature Ts of an initial value set in advance for the productivity lowering operation by using the derived correction amount ΔTs (S604). That is, the controller 21 sets the updated setting temperature Ts obtained by adding the correction amount ΔTs corresponding to the toner characteristic value T1 to the initial value setting temperature Ts.

For example, the toner characteristic value at the preset initial value setting temperature (setting temperature Ts before update) is set as the first toner characteristic value. On the other hand, when the toner characteristic value T1 read from the first storage portion 161 is the second toner characteristic value in which the toner is less likely to be melted than the first toner characteristic value, the controller 21 derives the correction amount ΔTs for correcting the setting temperature to be high according to the second toner characteristic value. The controller 21 corrects the setting temperature Ts before update, which is the setting temperature, by using the derived correction amount.

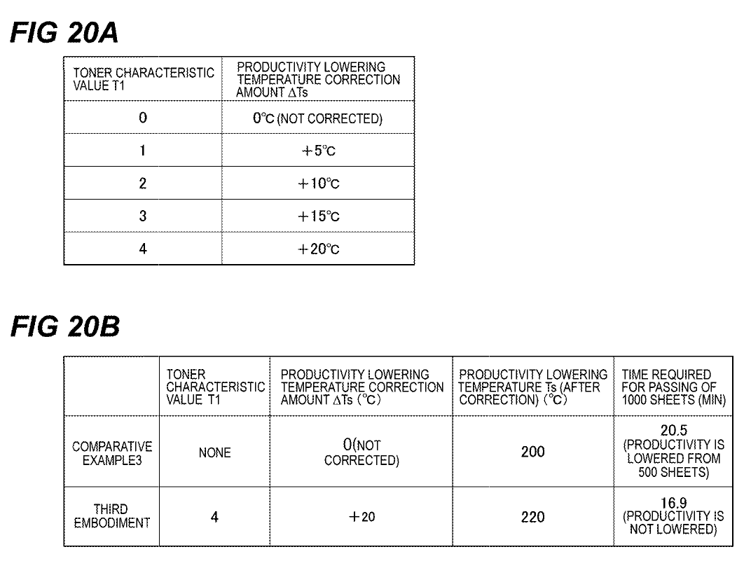

Here, as illustrated in FIG. 20A, the toner characteristic value T1 serving as the toner melting characteristic information is divided into five levels, and 4 is set to the maximum with 0 as a reference, and the toner characteristic value T1 is set to be advantageous with respect to the hot offset as the number increases. That is, the toner characteristic value T1 is set such that the toner is less likely to be melted as the number increases with reference to 0. The correction amount ΔTs for correcting the initial value setting temperature Ts is set to increase as the number (numerical value) of the toner characteristic value T1 increases. The table illustrated in FIG. 20A (the table indicating the relationship between the toner characteristic value T1 and the correction amount ΔTs of the productivity lowering temperature) is stored in the third storage portion 163 of the controller 21.

As described above, the toner characteristic value T1 stored in the first storage portion 161 is a value that is appropriately updated from the toner characteristic value T2 stored in the second storage portion 162 and the toner supply amount from the toner bottle 150 to the developing device 104.

After correcting the setting temperature Ts, the controller 21 sets the job conditions (S605) and starts the fixing operation (S606). That is, the controller 21 starts energization to the heater 16, drives the fixing drive motor M to rotate the pressure roller 22, and heats the fixing belt 20. When the fixing belt 20 or the heater 16 reaches the target temperature, passing of the recording material is started (S606).

During the print operation, the temperature detection portion 19 determines the end portion temperature of the fixing belt 20 (S607). Here, in a case where the end portion temperature of the fixing belt 20 is equal to or higher than the setting temperature Ts (Yes in S607), the operation of lowering the productivity is performed (S608). On the other hand, in a case where the end portion temperature of the fixing belt 20 is lower than the setting temperature Ts (No in S607), the print operation is continued without changing the productivity. When there is the next job (No in S609), the print operation is continued, and the end portion temperature is determined again (S607). If the job has ended (Yes in S609), the print operation is ended.

As described above, according to the third embodiment, in order to correct the setting temperature Ts to the setting temperature according to the characteristic information of the contained toner when performing the productivity lowering operation, the productivity lowering operation is performed for the optimum operation time according to the characteristic information of the toner. As a result, the operation time for lowering the productivity can be shortened, and the productivity can be improved.

### Comparison of Operation between Comparative Example 3 and Third Embodiment

The print operations of Comparative Example 3 and the third embodiment were compared under the following conditions.

Print conditions were a main body conveyance speed of 300 mm/s, a print speed of 60 sheets/min, a sheet type: CS064 (A5R size), a temperature control temperature: 180°C, and a productivity lowering temperature Ts (before update): 200°C. In addition, as a job condition, a job of a single size was executed in which 1000 A5R size recording materials continuously passed.

In Comparative Example 3, the end portion temperature detected by the temperature detection portion 19 reached the productivity lowering temperature Ts = 200°C at the time of passing of 500 sheets, and the operation shifted to the productivity lowering operation. In Comparative Example 3, when the detected temperature reached the productivity lowering temperature Ts, the print speed was reduced from 60 sheets/min to 42 sheets/min.

On the other hand, in the third embodiment, since the toner melting characteristic was the toner characteristic value T1 = 4, the productivity lowering temperature Ts was changed from the reference temperature 200°C to 220°C based on the toner melting characteristic information illustrated in FIG. 20A.

In the third embodiment, the end portion temperature detected by the temperature detection portion 19 was around 215°C even at the time of passing of 1000 sheets, and did not reach the productivity lowering temperature Ts = 220°C. Therefore, the operation did not shift to the productivity lowering operation while 1000 sheets passed, and the print speed was maintained at 60 sheets/min until the operation was ended.

FIG. 20B illustrates a comparison result of the print operation. As illustrated in FIG. 20B, when compared in the required time for passing of 1000 sheets, the required time was 20.5 minutes in Comparative Example 3, whereas the required time was 16.9 minutes in the third embodiment, and the required time was shortened by about 3.6 minutes. From this, according to the present embodiment, it has been confirmed that productivity can be improved.

In the above-described embodiment, as a configuration of deriving the correction amount from the characteristic value of the toner, the configuration of deriving the correction amount from the characteristic value of the toner by using the table of the characteristic value of the toner and the correction amount of the setting temperature has been exemplified, but the present invention is not limited thereto. For example, a configuration may be used in which the correction amount is derived from the characteristic value of the toner by using a program for reading a physical property value of the toner and calculating the correction amount.

In the embodiment described above, the fan is employed as a cooling portion, but the present invention is not limited thereto. For example, it is also possible to cope with changing conditions (an opening width, an opening area, etc.) for the shutter disposed to face the fan. It is also possible to cope with changing light shielding conditions of a light shielding member in a configuration using a halogen heater as a heating source.

In the embodiment described above, the cooling end temperature and the productivity lowering temperature are controlled to be changed, but the cooling end temperature and the productivity lowering temperature may be operated in combination. Further, the control may be changed according to a combination of a target adjustment control temperature during sheet passing, recording material information, and external environment information.

Furthermore, in the above-described embodiment, the temperature correction flow for the monochrome mode has been described, but the correction flow in the color mode can also be controlled by using a similar method. Melting characteristic information (characteristics related to hot offset performance) of the toner stored in the first storage portion 161 (developing device 104) is read for each of yellow (Ty), magenta (Tm), cyan (Tc), and black (Tk). After the reading, the smallest T (T of the toner in which the hot offset is most likely to occur) is adopted, and the read value is converted into the correction amount, whereby the productivity can be maximized within a range in which the hot offset is not generated.

Further, in the above-described embodiment, the configuration in which the temperature detection portion 19 that detects the temperature of the heating member is used as the temperature detection portion has been exemplified, but the present invention is not limited thereto. For example, a configuration may be adopted in which the temperature detection portion 18 that detects the temperature of the fixing rotating member heated by the heating member is used. Alternatively, both temperature detection portions may be used.

Further, in the above embodiments, a printer has been exemplified as the image forming apparatus, but the present invention is not limited thereto. For example, another image forming apparatus such as a copying machine or a FAX machine, or another image forming apparatus such as a multifunction peripheral combining these functions may be used. Alternatively, the image forming apparatus may be an image forming apparatus that uses a recording material bearing member transfers toner images of respective colors in a sequentially superimposed manner onto a recording material born on the recording material bearing member. Similar effects can be obtained by applying the present invention to these image forming apparatuses.

### Fourth Embodiment

When the toner is mass-produced, there are variations in an amount and a physical property value of a contained material. Even if a variation of the toner is within a specified range, the variation is directly connected to the melting characteristics of the toner, and affects the separation performance of a recording material in the fixing device and the fixing performance related to the image quality.

Even in the fixing device having the separation claw, for example, in a case where a recording material having low rigidity such as thin paper is used in a high humidity environment, it is difficult to separate the recording material from a fixing film, and thus, it is desirable to set the fixing temperature low. For energy saving, the fixing temperature in the fixing device is desirably set low.

On the other hand, in a fixing device in which the fixing temperature is set low, for example, in a case where a toner having good separation performance is used, the amount of heat supplied to the toner is excessively suppressed, and there is a problem that a density, gloss, and a color gamut deteriorate and thus the image quality deteriorates.

Therefore, in the present embodiment, it will be described that any one of two or more pieces of toner characteristic value information is selected according to an environment or a recording material, the setting temperature is corrected, and the temperature adjustment operation is performed.

The image forming apparatus in the present embodiment overlaps with that described with reference to FIG. 1, and thus a description thereof will be omitted.

The first toner characteristic value T1 and the second toner characteristic value T2 stored in the first storage portion 161 are values necessary for correcting the fixing temperature. The first toner characteristic value T1 stored in the first storage portion 161 is a toner characteristic value related to the fixing performance. The second toner characteristic value T2 stored in the first storage portion is a toner characteristic value related to the separation performance.

In the present embodiment, the correction value of the fixing temperature is calculated based on the first toner characteristic value T1, but it is obvious that the correction value of the fixing temperature varies depending on the toner type and the configuration of the fixing device. The first toner characteristic value T1 is a numerical value related to fixability. Here, the fixability is ease of fixing the toner to the recording material. When the fixability is high, the toner can be fixed to the recording material even with a small amount of heat. As the first toner characteristic value T1 related to the fixing performance, for example, there is a toner viscosity when the toner is melted, but the first toner characteristic value T1 is not limited thereto, and a glass transition temperature or the like can also be used.

Similarly, in the present embodiment, the correction value of the fixing temperature is calculated based on the second toner characteristic value T2, but it is obvious that the correction value of the fixing temperature varies depending on the toner type and the configuration of the fixing device. The second toner characteristic value T2 is a numerical value related to separability. Here, the separability is ease of separation between the fixing belt and the recording material on the downstream side of the nip portion (outlet of the nip portion) of the fixing device in the conveyance direction. When the separability is high, the toner peels off even at a high temperature. Examples of the second toner characteristic value T2 related to the separation performance include, but are not limited to, the wax content of the toner, and it is also possible to use a coating area ratio of the wax or the like.

The first toner characteristic value T1 and the second toner characteristic value T2 stored in the first storage portion 161 are values that are updated as appropriate from the toner supply amount from the toner bottle 150 to the developing device 104, and a toner characteristic value Q1 stored in the second storage portion 162, and a toner characteristic value Q2 different from the toner characteristic value Q1, respectively.

The first toner characteristic value T1 and the second toner characteristic value T2 stored in the first storage portion 161, and the toner characteristic value Q1 and the toner characteristic value Q2 stored in the second storage portion 162 are read by the image forming apparatus side, sent to the controller 21, and used for controlling the operation.

### Fixing Device

Since the fixing device 100 in the present embodiment overlaps with that described using FIG. 3, the description thereof will be omitted.

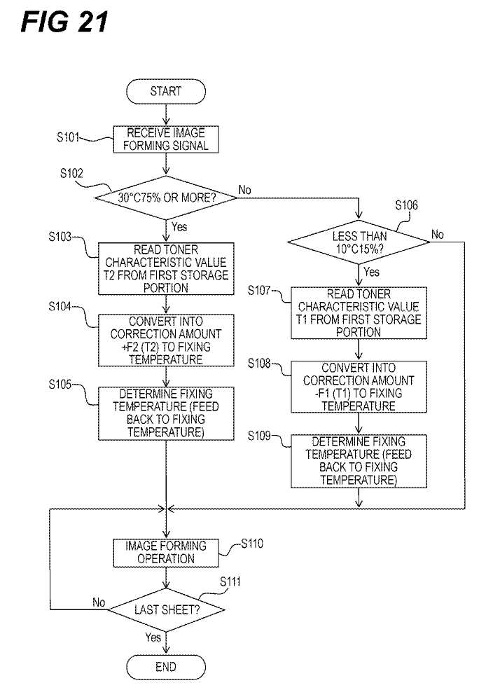

An image forming apparatus according to the fourth embodiment will be described with reference to FIG. 21. FIG. 21 illustrates a control flow from reception of an image forming signal by the image forming apparatus of the present embodiment to the end of an image forming operation.

Upon receiving the image forming signal (S101), the controller 21 determines whether or not the condition is a target condition for correcting the fixing temperature.

Here, the target condition for correcting the fixing temperature is determined by a temperature or a humidity as information regarding the environment in which the image forming apparatus is installed.

The image forming apparatus includes an environment detection portion 170 that detects a temperature or a humidity as information regarding the environment. The controller 21 causes the environment detection portion 170 to detect the temperature or the humidity of the environment in which the image forming apparatus is installed. Here, the environment detection portion that detects both the temperature and the humidity is exemplified, but the present invention is not limited thereto, and the environment detection portion may detect one of the temperature and the humidity.

Note that, here, the configuration in which the image forming apparatus includes the environment detection portion 170 that detects a temperature or a humidity as the information regarding the environment has been exemplified as a configuration of obtaining the information regarding the environment, but the present invention is not limited thereto. For example, other configurations such as a configuration in which a temperature or a humidity as the information regarding the environment is obtained from the outside of the apparatus or a configuration in which a temperature or a humidity is set from the operation panel 112 may be used.

In the present embodiment, the setting temperature (a target temperature and a fixing temperature) is corrected by using the first toner characteristic value T1 or the second toner characteristic value T2 of the toner stored in the first storage portion 161 according to the temperature or the humidity as the information regarding the environment in which the image forming apparatus is installed.

Here, the temperature or the humidity detected by the environment detection portion 170 is set to 10°C 15% that is a first threshold and 30°C 75% that is a second threshold larger than the first threshold. These are examples, and the present invention is not limited thereto.

In a case where the temperature or the humidity detected by the environment detection portion 170 is 30°C 75% or more (S102), the controller 21 reads the second toner characteristic value T2 stored in the first storage portion 161 (S103).

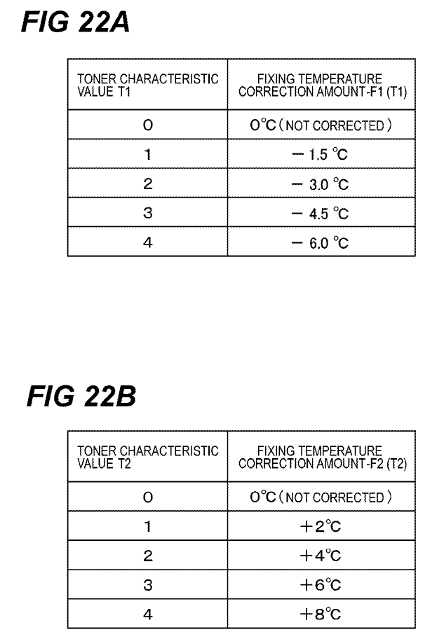

The read second toner characteristic value T2 is converted into the amount of correction to the fixing temperature +F2 (T2) from the table illustrated in FIG. 22B (S104), and fed back to the fixing temperature such that the fixing temperature is determined (S105).

The table illustrated in FIG. 22B is a table indicating the relationship between the second toner characteristic value T2, which is a numerical value related to the separability, and the correction amount +F2 (T2) of the fixing temperature, and is stored in the third storage portion 163 of the controller 21. The table illustrated in FIG. 22B illustrates a case where the temperature or the humidity of coated paper having a basis weight of 50 to 100 gsm is 30°C 75% (absolute humidity of 22.77 g/m³) or more. The table illustrated in FIG. 22B is an example, and the present invention is not limited thereto.

As illustrated in FIG. 22B, the second toner characteristic value T2 related to the separation performance is a value to be converted into the correction amount +F2 (T2) for correcting the fixing temperature to a higher temperature as the numerical value increases with 0 as a reference. In addition, the correction amount +F2 (T2) of the fixing temperature is a function determined by the second toner characteristic value T2, the process speed, the sheet type, or the basis weight.

The image forming operation is executed at the determined fixing temperature (S110), and the job is ended at the time at which the last sheet passes (S111).

When the temperature or the humidity detected by the environment detection portion 170 is lower than 10°C 15% (S106), the controller 21 reads the first toner characteristic value T1 stored in the first storage portion 161 (S107).

The read first toner characteristic value T1 is converted into the correction amount -F1 (T1) to the fixing temperature from the table illustrated in FIG. 22A (S108), and fed back to the fixing temperature such that the fixing temperature is determined (S109).

The table illustrated in FIG. 22A is a table indicating the relationship between the first toner characteristic value T1, which is a numerical value related to fixability, and the correction amount -F1 (T1) of the fixing temperature, and is stored in the third storage portion 163 of the controller 21. The table illustrated in FIG. 22A illustrates a case where the temperature or the humidity of plain paper having a basis weight of 50 to 100 gsm is lower than 10°C 15% (absolute humidity of 1.41 g/m³). The table illustrated in FIG. 22A is an example, and the present invention is not limited thereto.

As illustrated in FIG. 22A, the first toner characteristic value T1 related to the fixing performance is a value to be converted into the correction amount -F1 (T1) for correcting the fixing temperature to a lower temperature as the numerical value increases with 0 as a reference. In addition, the correction amount -F1 (T1) of the fixing temperature is a function determined by the first toner characteristic value T1, the process speed, the sheet type, or the basis weight.

The image forming operation is executed at the determined fixing temperature (S110), and the job is ended at the time at which the last sheet passes (S111).

In a case where the temperature or the humidity detected by the environment detection portion 170 is less than 30°C 75% (S102) and 10°C 15% or more (S106), the controller 21 does not read the toner characteristic values T1 and T2 stored in the first storage portion 161.

In a case where the toner characteristic values T1 and T2 are not read, the fixing temperature is determined without temperature correction (S109). The image forming operation is executed at the determined fixing temperature (S110), and the job is ended at the time at which the last sheet passes (S111).

As described above, in the present embodiment, in a case where the temperature or the humidity detected by the environment detection portion 170 is less than 10°C 15% that is the first threshold, the fixing temperature is corrected by using the first toner characteristic value T1. In a case where the temperature or the humidity detected by the environment detection portion 170 is equal to or higher than 30°C 75% that is the second threshold, the fixing temperature is corrected by using the second toner characteristic value T2. In a case where the temperature or the humidity detected by the environment detection portion 170 is equal to or more than the first threshold and less than the second threshold, the fixing temperature is not corrected. By correcting the fixing temperature as appropriate by using the two characteristic values of the contained toner, it is possible to improve image quality by suppressing deterioration in density, gloss, and color gamut while realizing reduction in power consumption. That is, according to the present embodiment, it is possible to improve the image quality while suppressing the separation failure.

Note that, in the present embodiment, the control flow in a case where the temperature or the humidity detected by the environment detection portion 170 is 10°C 15% that is the first threshold and 30°C 75% that is the second threshold more than the first threshold has been described as an example, but the present invention is not limited thereto.

For example, the temperature or the humidity detected by the environment detection portion 170 may be set to 30°C 75% which is a predetermined threshold. In this case, in a case where the temperature or the humidity detected by the environment detection portion 170 is less than 30°C 75% that is the predetermined threshold, the fixing temperature is corrected by using the first toner characteristic value T1. In a case where the temperature or the humidity detected by the environment detection portion 170 is equal to or more than 30°C 75% that is the predetermined threshold, the fixing temperature is corrected by using the second toner characteristic value T2. Even with such a configuration, the same effects as those of the above-described configuration can be obtained.

### Fifth Embodiment

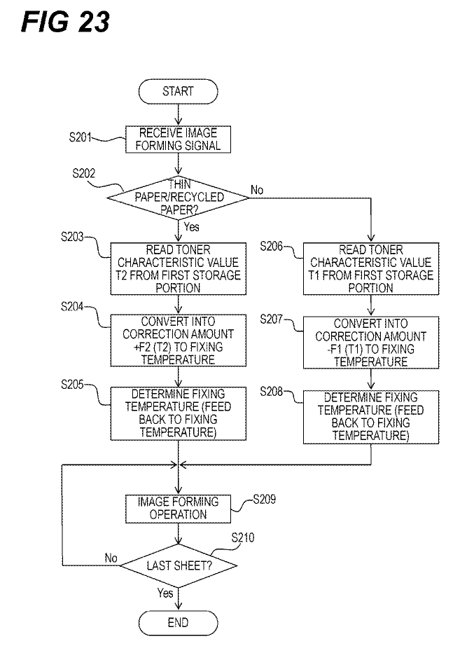

An image forming apparatus according to a fifth embodiment will be described with reference to FIG. 23. FIG. 23 illustrates a control flow from reception of an image forming signal by the image forming apparatus of the present embodiment to the end of an image forming operation.

When the controller 21 receives the image forming signal (S201), a target condition for correcting the fixing temperature is determined.

Here, the target condition for correcting the fixing temperature is determined by the type of the recording material (sheet type) serving as information regarding the recording material.

The controller 21 obtains the type of the recording material as information regarding the recording material. The type of the recording material as the information regarding the recording material is set from the operation panel 112 (see FIG. 2). Note that the information regarding the recording material is not limited to the setting from the operation panel 112, and may be detected by a sensor (not illustrated) inside the apparatus, or may be transmitted from the outside of the apparatus, for example. In addition, the type of the recording material is also an example, and is not limited thereto.

In the present embodiment, the setting temperature (a target temperature and a fixing temperature) is corrected by using the first toner characteristic value T1 or the second toner characteristic value T2 of the toner stored in the first storage portion 161 according to the type of the recording material (sheet type).

Here, the sheet type as the type of the recording material is thin paper/recycled paper as a predetermined recording material and a recording material other than the predetermined recording material. These are examples, and the present invention is not limited thereto.

In a case where the type of the recording material is thin paper/recycled paper (S202), the controller 21 reads the second toner characteristic value T2 stored in the first storage portion 161 (S203).

The read second toner characteristic value T2 is converted into the correction amount +F2 (T2) to the fixing temperature from the table illustrated in FIG. 22B (S204), and fed back to the fixing temperature such that the fixing temperature is determined (S205).

The image forming operation is executed at the determined fixing temperature (S209), and the job is ended at the time at which the last sheet passes (S210).

In a case where the type of the recording material is a recording material other than thin paper/recycled paper (S202), the controller 21 reads the first toner characteristic value T1 stored in the first storage portion 161 (S206).

The read first toner characteristic value T1 is converted into the correction amount -F1 (T1) to the fixing temperature from the table illustrated in FIG. 22A (S207), and fed back to the fixing temperature such that the fixing temperature is determined (S208).

The image forming operation is executed at the determined fixing temperature (S209), and the job is ended at the time at which the last sheet passes (S210).

As described above, in the present embodiment, in a case where the type of the recording material is a recording material other than thin paper/recycled paper which is a predetermined recording material, the fixing temperature is corrected by using the first toner characteristic value T1. In addition, in a case where the type of the recording material is thin paper/recycled paper that is the predetermined recording material, the fixing temperature is corrected by using the second toner characteristic value T2. By correcting the fixing temperature as appropriate by using the two characteristic values of the contained toner, it is possible to improve image quality by suppressing deterioration in density, gloss, and color gamut while realizing reduction in power consumption. That is, according to the present embodiment, it is possible to improve the image quality while suppressing the separation failure.

Note that, in the present embodiment, the control flow in a case where the type of the recording material is a recording material other than thin paper/recycled paper that is a predetermined recording material and thin paper/recycled paper as the predetermined recording material has been described as an example, but the present invention is not limited thereto.

For example, the type of the recording material may be plain paper that is a first recording material, coated paper that is a second recording material different from the first recording material, and a third recording material other than plain paper that is the first recording material and coated paper that is the second recording material. In this case, in a case where the type of the recording material is plain paper, the fixing temperature is corrected by using the second toner characteristic value T2. In a case where the recording material is coated paper, the fixing temperature is corrected by using the first toner characteristic value T1. In a case where the recording material is the third recording material other than plain paper and coated paper, the fixing temperature is not corrected. Even with such a configuration, the same effects as those of the above-described configuration can be obtained.

Furthermore, in the present embodiment, the type of the recording material is exemplified as the information regarding the recording material, but the present invention is not limited thereto, and for example, the basis weight of the recording material may be used.

For example, the basis weight of the recording material is set to 100 gsm that is a predetermined basis weight. In this case, in a case where the basis weight of the recording material is less than 100 gsm that is the predetermined basis weight, the fixing temperature is corrected by using the second toner characteristic value T2. In a case where the basis weight of the recording material is not less than 100 gsm that is the predetermined basis weight, the fixing temperature is corrected by using the first toner characteristic value T1. Even with such a configuration, the same effects as those of the above-described configuration can be obtained.

Alternatively, the basis weight of the recording material may be set to 100 gsm that is a first basis weight and 300 gsm that is a second basis weight larger than the first basis weight. In this case, in a case where the basis weight of the recording material is less than 100 gsm that is the first basis weight, the fixing temperature is corrected by using the second toner characteristic value T2.

In a case where the basis weight of the recording material is not less than 300 gsm that is the second basis weight larger than the first basis weight, the fixing temperature is corrected by using the first toner characteristic value T1. In a case where the basis weight of the recording material is equal to or more than the first basis weight and less than the second basis weight, the fixing temperature is not corrected. Even with such a configuration, the same effects as those of the above-described configuration can be obtained.

### Sixth Embodiment

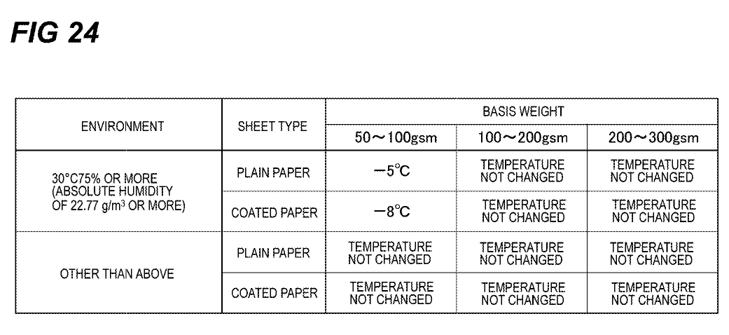

An image forming apparatus according to a sixth embodiment will be described with reference to FIGS. 24-30.

In the fourth embodiment described above, the description has been made by exemplifying the configuration in which the fixing temperature is corrected by using the first toner characteristic value T1 or the second toner characteristic value T2 of the toner stored in the first storage portion 161 according to the information regarding the environment.

In the fifth embodiment described above, the description has been made by exemplifying the configuration in which the fixing temperature is corrected by using the first toner characteristic value T1 or the second toner characteristic value T2 of the toner stored in the first storage portion 161 according to the information regarding the recording material.

In the present embodiment, a configuration of correcting the fixing temperature by using the first toner characteristic value T1 or the second toner characteristic value T2 of the toner stored in the first storage portion 161 according to either the information regarding the environment or the information regarding the recording material will be described as an example.

### Design for Ensuring Separation Performance

First, a design for ensuring separation performance will be described with reference to FIG. 24. In the design for ensuring the separation performance, correction control of the fixing temperature using the toner characteristic value of the present embodiment is not implemented.

Conventionally, a fixing temperature (X1) serving as a reference is determined based on the melting characteristics of a toner having the worst fixing performance including variations in mass production manufacturing. For conditions requiring particularly high separation performance, the fixing temperature at which a recording material is separable is set based on the melting characteristics of the toner having the worst separation performance. Therefore, the fixing temperature is corrected by the correction amount illustrated in FIG. 24.

Hereinafter, the correction amount of the fixing temperature will be described.

In a case where a recording material having low rigidity such as thin paper passes in a high humidity environment, the recording material is hardly separated from the fixing belt, and there is a possibility that a separation failure occurs. Therefore, the occurrence of separation failure is suppressed by lowering the temperature of the fixing belt under the above-described conditions.

In a case where the type of the recording material is plain paper that is the first recording material, in an environment of 30°C 75% (absolute humidity of 22.77 g/m³) or more that is a predetermined threshold, the fixing temperature (X1) that is a preset reference is corrected for the paper having a basis weight of 50 to 100 gsm by an amount corresponding to the correction amount. That is, the preset fixing temperature (X1) is corrected to a temperature lower by -5°C, which is equivalent to the correction amount. The fixing temperature is not corrected in other environments and basis weights.

In addition, in a case of coated paper that is the second recording material different from that of the first recording material as the type of the recording material, in an environment of 30°C 75% (absolute humidity of 22.77 g/m³) or more, the fixing temperature (X1) is corrected by the correction amount for paper having a basis weight of 50 to 100 gsm. That is, the preset fixing temperature (X1) is corrected to a temperature lower by -8°C, which is equivalent to the correction amount. The fixing temperature is not corrected in other environments and basis weights.

Furthermore, the fixing temperature is corrected based on the first toner characteristic value T1 in order to reduce power consumption.

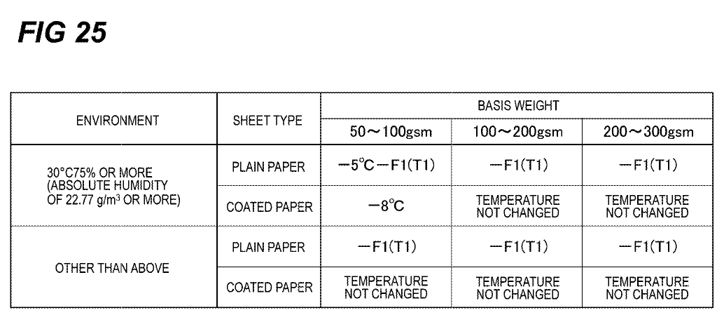

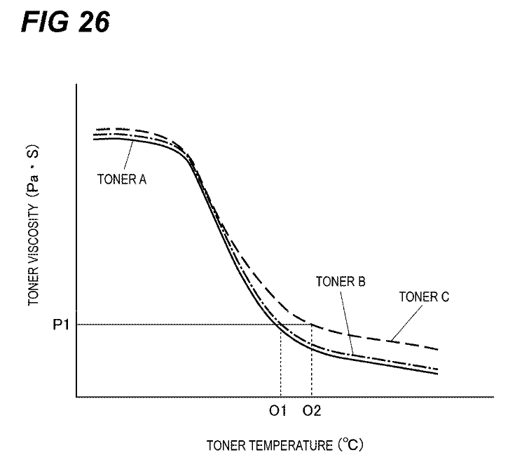

FIG. 26 illustrates a relationship between the toner temperature and the toner viscosity. The toners A to C are toners under the same formulation, but have different viscoelastic characteristics due to variations during mass production, and the toner C is a toner having the worst fixing performance due to variations during mass production. The fixing device heats the toner so that the viscosity of the toner is P1 or less to fix the toner to the recording material. The temperature at which the toner A and the toner B have the fixable viscosity P1 is O1. On the other hand, at the temperature at which the toner C has the fixable viscosity P1 is O2, which is higher than the temperature O1, the toner C has low fixing performance, and requires much energy for fixing. The toner A and the toner B are taken up as representatives. The toner characteristic values T1 of the toner A and the toner B are T1 of the same level. FIG. 25 illustrates a result of correcting the fixing temperature by the correction amount -F1 (T1) based on the toner characteristic value T1. As illustrated in FIG. 25, in a case where the type of the recording material is plain paper, the fixing temperature is corrected. However, in a case where the type of the recording material is coated paper, since the recording material is used when it is desired to output a glossy product, the fixing temperature is not corrected.

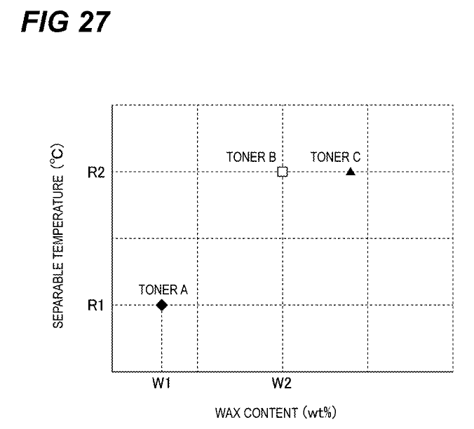

FIG. 27 illustrates a relationship between the content of the wax and the separable temperature of the toner. The separable temperature of the toner A is R1, the separable temperature of the toner B is R2, and the fixing temperature needs to be lower than the separable temperature in order to separate the recording material from the fixing belt. Therefore, even when a glossy product is required, the temperature is set to be lower than the separable temperature R1 of the toner A. When a toner having good separation performance such as the toner B is fixed in this setting, the fixing temperature is unnecessarily lowered, and an image with reduced density, color gamut, and gloss is output.

### Fixing Temperature Correction Flow in Present Embodiment

Therefore, in the present embodiment, the fixing temperature is corrected by using the first toner characteristic value T1 or the second toner characteristic value T2 of the toner stored in the first storage portion 161 according to either the information regarding the environment or the information regarding the recording material. An operation of adjusting the temperature of the nip portion to the corrected fixing temperature is performed.

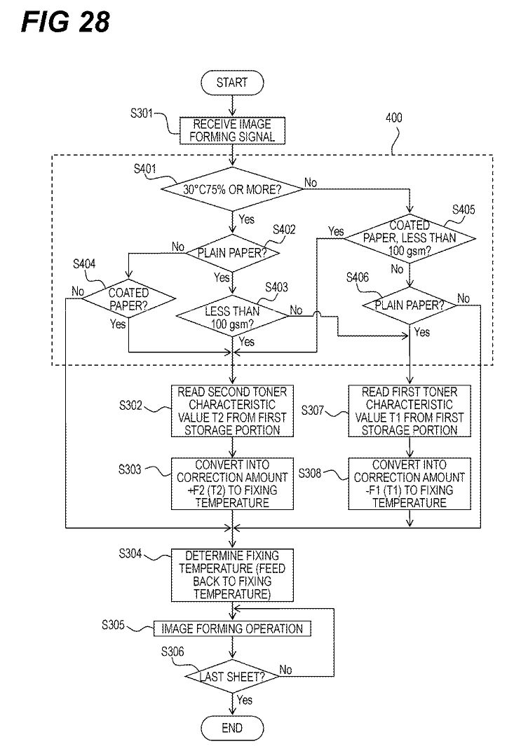

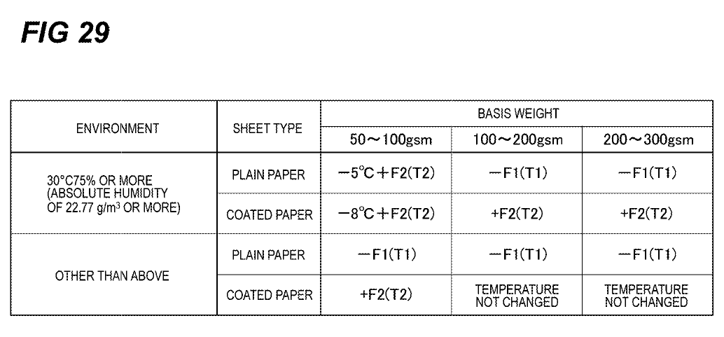

FIG. 28 illustrates a control flow from reception of an image forming signal by the image forming apparatus of the present embodiment to the end of an image forming operation. FIG. 29 illustrates the correction amount of the fixing temperature determined in this flow.

When the controller 21 receives the image forming signal (S301), it is determined whether or not the condition is a target condition for correcting the fixing temperature in a dashed line region 400 illustrated in FIG. 28.

The target condition for correcting the fixing temperature is determined by information regarding the environment in which the image forming apparatus is installed or information regarding the recording material. As illustrated in FIG. 29, the target condition for correcting the fixing temperature is determined by a temperature or a humidity serving as the information regarding the environment, the type of the recording material (sheet type) serving as the information regarding the recording material, and the basis weight of the recording material.

The image forming apparatus includes an environment detection portion 170 that detects a temperature or a humidity as information regarding an environment in which the image forming apparatus is installed. The controller 21 causes the environment detection portion 170 to detect the temperature or the humidity of the environment in which the image forming apparatus is installed. Here, the environment detection portion that detects both the temperature and the humidity is exemplified, but the present invention is not limited thereto, and the environment detection portion may detect one of the temperature and the humidity.

Note that, here, the configuration in which the image forming apparatus includes the environment detection portion 170 that detects a temperature or a humidity as the information regarding the environment has been exemplified as a configuration of obtaining the information regarding the environment, but the present invention is not limited thereto. For example, other configurations such as a configuration in which a temperature or a humidity as the information regarding the environment is obtained from the outside of the apparatus or a configuration in which a temperature or a humidity is set from the operation panel 112 may be used.

Furthermore, the controller 21 obtains the type of the recording material and the basis weight of the recording material as the information regarding the recording material. The type of the recording material and the basis weight of the recording material serving as the information regarding the recording material are set from the operation panel 112 (see FIG. 2). The information regarding the recording material is not limited to the setting from the operation panel 112, and may be detected by a sensor (not illustrated) inside the apparatus, or may be transmitted from the outside of the apparatus, for example. In addition, the type of the recording material and the basis weight of the recording material are also examples, and the information regarding the recording material is not limited thereto.

Here, the temperature or the humidity detected by the environment detection portion 170 is set to 30°C 75% which is a predetermined threshold. In addition, the type of the recording material is plain paper which is a first recording material, coated paper which is a second recording material different from the first recording material, paper other than plain paper and coated paper, which is a third recording material other than the first recording material and the second recording material. Furthermore, the basis weight of the recording material is set to 100 gsm which is a predetermined basis weight. These are examples, and the present invention is not limited thereto.

In a case where the temperature or the humidity detected by the environment detection portion 170 is 30°C 75% or more (S302), the type of the recording material is plain paper (S303), and the basis weight of the recording material is less than 100 gsm (S304), the controller 21 reads the second toner characteristic value T2 stored in the first storage portion 161 (S305).

In a case where the temperature or the humidity detected by the environment detection portion 170 is 30°C 75% or more (S302) and the type of the recording material is coated paper (S310), the controller 21 reads the second toner characteristic value T2 (S305).

In addition, in a case where the temperature or the humidity detected by the environment detection portion 170 is less than 30°C 75% (S302), the type of the recording material is coated paper, and the basis weight of the recording material is less than 100 gsm (S311), the controller 21 reads the second toner characteristic value T2 (S305).

The read second toner characteristic value T2 is converted into the correction amount +F2 (T2) to the fixing temperature from the table illustrated in FIG. 22B (S306), and fed back to the fixing temperature such that the fixing temperature is determined (S307).

The image forming operation is executed at the determined fixing temperature (S308), and the job is ended at the time at which the last sheet passes (S309).

In addition, in a case where the temperature or the humidity detected by the environment detection portion 170 is 30°C 75% or more (S302), the type of the recording material is plain paper (S303), and the basis weight of the recording material is 100gsm or more (S304), the controller 21 reads the first toner characteristic value T1 stored in the first storage portion 161 (S313).

In addition, in a case where the temperature or the humidity detected by the environment detection portion 170 is less than 30°C 75% (S302), the basis weight of the recording material is 100 gsm or more (S311), and the type of the recording material is plain paper (S312), the controller 21 reads the first toner characteristic value T1 (S313).

The read first toner characteristic value T1 is converted into the correction amount -F1 (T1) to the fixing temperature from the table illustrated in FIG. 22A (S314), and fed back to the fixing temperature such that the fixing temperature is determined (S307).

The image forming operation is executed at the determined fixing temperature (S308), and the job is ended at the time at which the last sheet passes (S309).

In a case where the temperature or the humidity detected by the environment detection portion 170 is 30°C 75% or more (S302) and the type of the recording material is paper other than plain paper and coated paper (S310), the controller 21 does not read the toner characteristic values T1 and T2 stored in the first storage portion 161.

Furthermore, in a case where the temperature or the humidity detected by the environment detection portion 170 is less than 30°C 75% (S302), the basis weight of the recording material is 100 gsm or more (S311), and the type of the recording material is paper other than plain paper and coated paper (S312), the controller 21 does not read the toner characteristic values T1 and T2 stored in the first storage portion 161.

In a case where the toner characteristic values T1 and T2 are not read, the fixing temperature is determined without temperature correction (S308). The image forming operation is executed at the determined fixing temperature (S308), and the job is ended at the time at which the last sheet passes (S309).

As described above, the fixing temperature is lowered based on the toner characteristic value T1 related to the fixing performance in a use environment of a general fixing device for plain paper. In a low-temperature environment where high fixing performance is required or coated paper where gloss of a product is required, the fixing temperature is not lowered, and the fixing temperature is raised based on the toner characteristic value T2 related to the separation characteristic. As a result, it is possible to improve image quality by suppressing deterioration in density, gloss, and color gamut while reducing power consumption. That is, according to the present embodiment, it is possible to improve the image quality while suppressing the separation failure.

### Effects of Present Embodiment

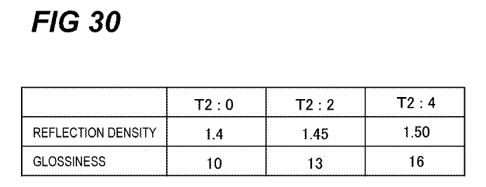

FIG. 30 illustrates an effect in a case where the present embodiment is implemented. The effect is indicated by a numerical value obtained by quantifying the reflection density and the glossiness of a product. The reflection density was measured with a reflection densitometer, and as a reflection densitometer, Tokyo Denshoku TC-6MC-D was used. With respect to the glossiness, a luminous flux having a prescribed opening angle at a prescribed incident angle was incident on an image surface, and a luminous flux having a prescribed opening angle reflected in a specular reflection direction was received to measure the glossiness. When the value of the toner characteristic value T2 increased with respect to the toner having good separation performance, both the reflection density and the glossiness increased, and the image quality was improved.

### Seventh Embodiment

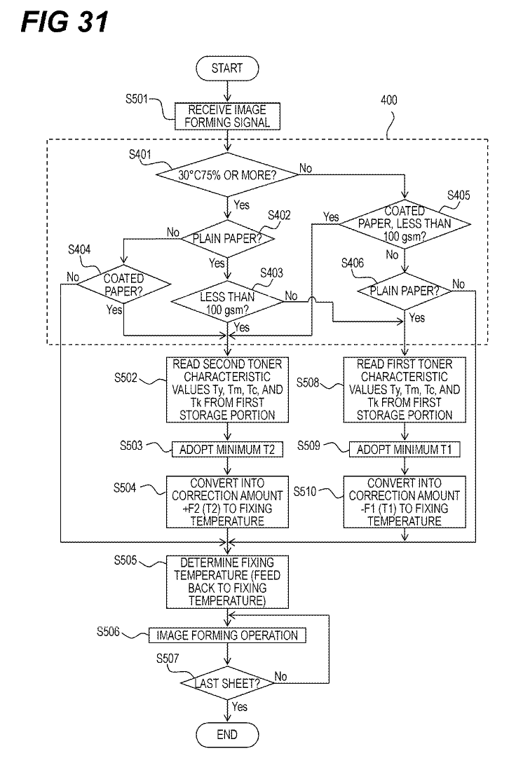

An image forming apparatus according to a seventh embodiment will be described with reference to FIG. 31. FIG. 31 illustrates a control flow from reception of an image forming signal by the image forming apparatus of the present embodiment to the end of an image forming operation.

In the fourth to sixth embodiments described above, the flow of correcting the fixing temperature for the monochrome mode has been described, but in the present embodiment, the flow of correcting the fixing temperature in the color mode will be described. In the following description, a description of the same parts as those of the sixth embodiment will be omitted, and different parts will be described.

When the controller 21 receives the image forming signal (S501), it is determined whether or not the condition is a target condition for correcting the fixing temperature in a dashed line region 400 illustrated in FIG. 31.

Note that the dashed line region 400 illustrated in FIG. 31 is similar to the dashed line region 400 illustrated in FIG. 28, and thus the description thereof will be omitted here.

In the present embodiment, the first toner characteristic value T1 and the second toner characteristic value T2 stored in the first storage portion 161 are stored for each color of yellow (Ty), magenta (Tm), cyan (Tc), and black (Tk).

Therefore, when reading the second toner characteristic value T2 stored in the first storage portion 161 (S502), the controller 21 reads the second toner characteristic value T2 of each of yellow (Ty), magenta (Tm), cyan (Tc), and black (Tk).

The smallest second toner characteristic value T2, which is the smallest value among the read second toner characteristic values T2, is adopted (S503). The adopted minimum second toner characteristic value T2 is converted into the correction amount +F2 (T2) to the fixing temperature from the table illustrated in FIG. 22B (S504), and fed back to the fixing temperature such that the fixing temperature is determined (S505).

The image forming operation is executed at the determined fixing temperature (S506), and the job is ended at the time at which the last sheet passes (S507).

In a case where the first toner characteristic value T1 stored in the first storage portion 161 is read (S508), the controller 21 reads the first toner characteristic value T1 of each of yellow (Ty), magenta (Tm), cyan (Tc), and black (Tk).

The first toner characteristic value T1, which is the smallest value among the read first toner characteristic values T1, is adopted (S509). The adopted minimum first toner characteristic value T1 is converted into the correction amount -F1 (T1) to the fixing temperature from the table illustrated in FIG. 22A (S510), and fed back to the fixing temperature such that the fixing temperature is determined (S505).

The image forming operation is executed at the determined fixing temperature (S506), and the job is ended at the time at which the last sheet passes (S507).

As described above, according to the present embodiment, even in a case where the first toner characteristic value T1 and the second toner characteristic value T2 stored in the first storage portion 161 are stored for each color, similarly to the above-described embodiment, it is possible to suppress deterioration in density, gloss, and color gamut and improve image quality while reducing power consumption. That is, also in the present embodiment, the image quality can be improved while suppressing the separation failure.

In the above-described embodiment, as a configuration of deriving the correction amount of the setting temperature (a target temperature and a fixing temperature) from the characteristic value of the toner, the configuration of converting the correction amount from the characteristic value of the toner by using the table of the characteristic value of the toner and the correction amount of the setting temperature has been exemplified, but the present invention is not limited thereto. For example, a configuration may be used in which the correction amount is derived from the characteristic value of the toner by using a program for reading a physical property value of the toner and calculating the correction amount.

Further, in the above-described embodiment, the configuration in which the temperature detection portion 19 that detects the temperature of the heating member is used as the temperature detection portion has been exemplified, but the present invention is not limited thereto. For example, a configuration may be adopted in which the temperature detection portion 18 that detects the temperature of the fixing rotating member heated by the heating member is used. Alternatively, both temperature detection portions may be used.

Further, in the above embodiments, a printer has been exemplified as the image forming apparatus, but the present invention is not limited thereto. For example, another image forming apparatus such as a copying machine or a FAX machine, or another image forming apparatus such as a multifunction peripheral combining these functions may be used. Alternatively, the image forming apparatus may be an image forming apparatus that uses a recording material bearing member transfers toner images of respective colors in a sequentially superimposed manner onto a recording material born on the recording material bearing member. Similar effects can be obtained by applying the present invention to these image forming apparatuses.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-080594, filed May 13, 2025, No. 2025-095683, filed Jun. 9, 2025, which is hereby incorporated by reference herein in its entirety.

What is claimed is:

1. An image forming apparatus comprising:
a fixing portion including a heating member, a fixing rotating member heated by the heating member, and a pressure rotating member configured to abut on the fixing rotating member to form a nip portion;
a temperature detection portion configured to detect a temperature of the fixing rotating member or the heating member;
a fixing cooling portion configured to cool the fixing rotating member or the pressure rotating member;
a controller configured to perform a fixing operation in which, in a first region where a recording material passes through the nip portion, the recording material passes through a second region having a smaller length in a width direction orthogonal to a conveyance direction of the recording material than the first region of the nip portion, and then performs a cooling operation using the fixing cooling portion until a temperature of a region through which outside the second region in the first region of the nip portion reaches a preset setting temperature; and
a storage portion that stores characteristic information of a contained toner, wherein
at the time of performing the cooling operation using the fixing cooling portion, the setting temperature is corrected based on the characteristic information of the toner stored in the storage portion, and the cooling operation using the fixing cooling portion is performed until the temperature of the region through which outside the second region in the first region of the nip portion reaches the corrected setting temperature.

2. An image forming apparatus comprising:
a fixing portion including a heating member, a fixing rotating member heated by the heating member, and a pressure rotating member configured to abut on the fixing rotating member to form a nip portion;
a temperature detection portion configured to detect a temperature of the fixing rotating member or the heating member;
a controller configured to, when performing a fixing operation in which, in a first region where a recording material passes through the nip portion, the recording material passes through a second region having a smaller length in a width direction orthogonal to a conveyance direction of the recording material than the first region of the nip portion, perform an operation of reducing the number of recording materials per time passing through the nip portion in a case where a temperature of a region through which outside the second region in the first region of the nip portion exceeds a preset setting temperature; and
a storage portion that stores characteristic information of a contained toner, wherein
when the fixing operation in which the recording material passes through the second region of the nip portion is performed, the setting temperature is corrected based on the characteristic information of the toner stored in the storage portion, and in a case where the temperature of the region through which outside the second region in the first region of the nip portion exceeds the corrected setting temperature, an operation of reducing the number of recording materials per time passing through the nip portion is performed.

3. The image forming apparatus according to claim 1, wherein the temperature detection portion is disposed at a position corresponding to a region through which outside the second region in the first region of the fixing rotating member or the heating member.

4. The image forming apparatus according to claim 1, wherein the characteristic information of the toner is a toner characteristic value related to a temperature for melting the toner, and
the controller derives a correction amount corresponding to the toner characteristic value read from the storage portion, and corrects the setting temperature by using the derived correction amount.

5. The image forming apparatus according to claim 1, wherein the characteristic information of the toner is a toner characteristic value related to a temperature for melting the toner, and
when a toner characteristic value at the preset setting temperature is a first toner characteristic value, in a case where the toner characteristic value read from the storage portion is a second toner characteristic value in which the toner is less likely to be melted than the first toner characteristic value, the controller derives a correction amount for correcting the setting temperature to be higher according to the second toner characteristic value, and corrects the setting temperature by using the derived correction amount.

6. The image forming apparatus according to claim 1, further comprising a developing portion configured to develop a latent image formed on an image bearing member with the toner, wherein
the developing portion includes, as the storage portion, a first storage portion that stores characteristic information of the toner contained in the developing portion, and
the characteristic information of the toner is characteristic information of the toner stored in the first storage portion.

7. The image forming apparatus according to claim 6, further comprising a toner containing portion in which a toner to be supplied to the developing portion is contained, wherein
the toner containing portion includes, as the storage portion, a second storage portion that stores characteristic information of the toner contained in the toner containing portion, and
the characteristic information of the toner is the characteristic information of the toner stored in the first storage portion, the characteristic information being appropriately updated from a toner supply amount from the toner containing portion to the developing portion and the characteristic information of the toner stored in the second storage portion.

8. The image forming apparatus according to claim 7, wherein the toner containing portion is detachably attached to the image forming apparatus.

9. An image forming apparatus comprising:
a fixing portion including a heating member, a fixing rotating member heated by the heating member, and a pressure rotating member configured to abut on the fixing rotating member to form a nip portion;
a temperature detection portion configured to detect a temperature of the fixing rotating member or the heating member;
a controller configured to perform an operation of adjusting a temperature of the nip portion to a preset setting temperature; and
a storage portion that stores a first toner characteristic value related to a contained toner and a second toner characteristic value different from the first toner characteristic value, wherein
the controller performs an operation of correcting the setting temperature by using the first toner characteristic value or the second toner characteristic value of the toner stored in the storage portion according to information regarding an environment and information regarding a recording material, and adjusting the temperature of the nip portion to the corrected setting temperature.

10. The image forming apparatus according to claim 9, wherein
the controller performs an operation of correcting the setting temperature by using the first toner characteristic value or the second toner characteristic value of the toner stored in the storage portion according to the information regarding the environment and adjusting the temperature of the nip portion to the corrected setting temperature.

11. The image forming apparatus according to claim 10, further comprising:
a detection portion configured to detect a temperature or a humidity as information regarding an environment in which the image forming apparatus is installed, wherein
the setting temperature is corrected by using the first toner characteristic value in a case where the temperature or the humidity detected by the detection portion is less than a first threshold,
the setting temperature is corrected by using the second toner characteristic value in a case where the temperature or the humidity detected by the detection portion is equal to or more than a second threshold greater than the first threshold, and
the setting temperature is not corrected in a case where the temperature or the humidity detected by the detection portion is equal to or more than the first threshold and less than the second threshold.

12. The image forming apparatus according to claim 10, further comprising:
a detection portion configured to detect a temperature or a humidity as information regarding an environment in which the image forming apparatus is installed, wherein
the setting temperature is corrected by using the first toner characteristic value in a case where the temperature or the humidity detected by the detection portion is less than a predetermined threshold, and
the setting temperature is corrected by using the second toner characteristic value in a case where the temperature or the humidity detected by the detection portion is equal to or more than the predetermined threshold.

13. The image forming apparatus according to claim 9, wherein
the controller performs an operation of correcting the setting temperature by using the first toner characteristic value or the second toner characteristic value of the toner stored in the storage portion according to the information regarding the recording material, and adjusting the temperature of the nip portion to the corrected setting temperature.

14. The image forming apparatus according to claim 13, wherein
the information regarding the recording material is a type of the recording material,
in a case where the type of the recording material is a recording material other than a predetermined recording material, the setting temperature is corrected by using the first toner characteristic value, and
in a case where the type of the recording material is the predetermined recording material, the setting temperature is corrected by using the second toner characteristic value.

15. The image forming apparatus according to claim 13, wherein
the information regarding the recording material is a type of the recording material,
in a case where the type of the recording material is a first recording material, the setting temperature is corrected by using the second toner characteristic value,
in a case where the type of the recording material is a second recording material different from the first recording material, the setting temperature is corrected by using the first toner characteristic value, and
in a case where the type of the recording material is a third recording material other than the first recording material and the second recording material, the setting temperature is not corrected.

16. The image forming apparatus according to claim 9, wherein
the controller performs an operation of correcting the setting temperature by using the first toner characteristic value or the second toner characteristic value of the toner stored in the storage portion according to either the information regarding the environment or the information regarding the recording material, and adjusting the temperature of the nip portion to the corrected setting temperature.

17. The image forming apparatus according to claim 9, wherein
the first toner characteristic value is a value to be converted into a correction amount for correcting the setting temperature to a lower temperature as a numerical value increases with 0 as a reference, and
the second toner characteristic value is a value to be converted into a correction amount for correcting the setting temperature to a higher temperature as a numerical value increases with 0 as a reference.

18. The image forming apparatus according to claim 9, wherein
the first toner characteristic value is a viscosity of the toner, and
the second toner characteristic value is a wax content.

19. The image forming apparatus according to claim 9, wherein
the first toner characteristic value is a numerical value related to fixability, and
the second toner characteristic value is a numerical value related to separability.

20. The image forming apparatus according to claim 10, further comprising:
a developing portion configured to develop a latent image formed on an image bearing member with the toner, wherein
the developing portion includes, as the storage portion, a first storage portion that stores a toner characteristic value related to the toner contained in the developing portion.
